(19) United States
(12) Patent Application Publication
(10) Pub. No.: US 2017/0008988 A1
(43) Pub. Date: Jan. 12, 2017

(54) BINDER FOR FORMATION OF CERAMIC OR FOR USE IN CONDUCTIVE PASTE, AND USE OF SAME

(71) Applicant: KURARAY CO., LTD., Kurashiki-shi (JP)

(72) Inventors: Takeshi KUSUDOU, Kurashiki-shi (JP); Yoshiaki ASANUMA, Kurashiki-shi (JP); Kazuki TOKUCHI, Chiyoda-ku (JP); Yuhi SHIMAZUMI, Kurashiki-shi (JP)

(73) Assignee: KURARAY CO., LTD., Kurashiki-shi (JP)

(21) Appl. No.: 15/119,204

(22) PCT Filed: Feb. 16, 2015
(86) PCT No.: PCT/JP2015/054063

§ 371 Date: Aug. 16, 2016

(30) Foreign Application Priority Data
Feb. 17, 2014 (JP) 2014-028000
Feb. 17, 2014 (JP) 2014-028001

(51) Int. Cl. C08F 216/38; C04B 35/634; C09D 5/24; C04B 41/80; C08F 18/08; C08F 16/06; C04B 41/00; H01B 1/22; C08K 3/08

(52) U.S. Cl. CPC C08F 216/38; H01B 1/22; C04B 35/6342; C09D 5/24; C08K 3/08; C08F 18/08; C08F 16/06; C04B 41/0054; C04B 41/80; C04B 41/009; C08F 2800/20; C08K 2003/0862; C08F 2500/17; C08K 2201/001

(57) ABSTRACT

There is provided a binder for ceramic formation or a conductive paste, comprising polyvinyl acetal having a degree of acetalization of from 50 to 85 mol %, a content of vinyl ester monomer unit of from 0.1 to 20 mol %, and having a viscosity-average degree of polymerization of from 200 to 5000, wherein a peak-top molecular weight (A) as measured by a differential refractive index detector and a peak-top molecular weight (B) as measured by an absorptiometer (measurement wavelength: 280 nm) in gel permeation chromatographic measurement of the polyvinyl acetal heated at 230° C. for 3 hours satisfy a formula (1) (A−B)/A<0.60 and the polyvinyl acetal has an absorbance in the peak-top molecular weight (B) of from 0.50×10⁻³ to 1.00×10⁻².

### TECHNICAL FIELD

The present invention relates to a binder for ceramic formation containing polyvinyl acetal. The present invention also relates to a binder for a conductive paste containing polyvinyl alcohol. The present invention further relates to uses thereof.

### BACKGROUND ART

Polyvinyl acetal is produced by acetalization reaction of a polyvinyl alcohol (hereinafter, sometimes abbreviated as “PVA”) and aldehyde compound in water under acidic conditions. Since polyvinyl acetal is used to produce a tough film and has a unique structure where it has both hydrophilic hydroxyl groups and hydrophobic acetal groups, a variety of polymers have been proposed. Among them, a polyvinyl formal produced from PVA and formaldehyde, a polyvinyl acetoacetal produced from PVA and acetaldehyde, and polyvinyl butyral produced from PVA and butyraldehyde are commercially important.

In particular, polyvinyl butyral has been widely used as a binder for ceramic formation, various binders and films, and the like, and it is especially commercially important.

Binders for ceramic formation are used as a binder for formation during the course of manufacture of a stacked capacitor and a circuit substrate for an IC chip. Among all, they are widely used as a binder used for preparation of a ceramic green sheet. A stacked capacitor and a circuit substrate for an IC chip are manufactured by a method in which an electrode is formed on a ceramic green sheet and stacked for pressure bonding, followed by simultaneous sintering of the electrode and ceramics and the like.

As a method of producing a ceramic green sheet, a method in which a ceramic slurry having polyvinyl acetal, ceramic powder, and an organic solvent as main components is applied on a carrier film, followed by drying and the like are employed.

Examples of performances required for a binder for ceramic formation include production of a ceramic slurry excellent in dispersibility and storage stability, a less amount of carbon residue after sintering, good adhesiveness in pressure bonding, and the like. When the dispersibility or the storage stability of the ceramic slurry is insufficient, a ceramic green sheet produced therefrom may have insufficient density, smoothness, and the like, resulting in poor adhesiveness. When there is a large amount of carbon residue in a shaped ceramic article after sintering, the shaped article may have insufficient electrical properties and the like.

In recent years, with increasing functions and downsizing of electronic devices, there is a demand for increase in capacity and downsizing on stacked ceramic capacitors. To meet such demand, ceramic powder used for a ceramic green sheet has a fine particle size of 0.5 μm or less and an attempt is made to coat it on a releasable support in a thin film form of, for example, 5 μm or less.

However, when ceramics powder having a fine particle size is used, the packing density and the surface area increase, causing an increase in the amount of binder resin to be used. Accordingly, the viscosity of the slurry composition for a ceramic green sheet is increased, so that coating sometimes becomes difficult or the ceramic powder itself may be dispersed poorly.

Meanwhile, there is limitation in downsizing of a stacked ceramic capacitor, and in order to increase in capacity or downsize while keeping the capacity of the stacked ceramic capacitor, the green sheet is required to be multilayered in addition to be thinner. For the stacked ceramic capacitor, an electrode layer is formed on a green sheet, and such green sheets formed with an electrode layer and green sheets not formed with it are laminated to obtain a composite lamination.

A procedure of forming such electrode layer includes a method in which an electrode layer is directly formed by a method of printing it on the green sheet and a case in which an electrode layer is formed on a carrier film by printing and the like to transfer the electrode layer by hot press from the carrier film to the green sheet.

However, in the step of pressing the green sheets for lamination, stronger press causes deformation in such green sheet and a conductor layer, and higher precision required for the stacked ceramic component is not achieved. On the other hand, weaker press in a conventional manufacturing method causes a weaker adhesion force between the green sheets or a green sheet and a conductor layer, resulting in upper and lower green sheets not closely adhering. When such poor adhesion occurs, there is a problem of generating a defect after sintering of the ceramic lamination to reduce the reliability of the component.

In addition, in the step of transferring a conductor layer from the carrier film to the green sheet by pressing, stronger press causes deformation in the conductor layer and the higher precision required for the stacked ceramic component is not achieved. In spite of that, weaker press in a conventional manufacturing method causes a weak adhesion strength between the green sheet and the conductor layer, resulting in the conductor layer not closely adhering to the green sheet. When such poor adhesion occurs, there is a problem of, not only failure in conductor layer formation, generating a defect after sintering of the ceramic lamination to reduce the reliability of the component.

Patent Reference No. 1 describes ceramic paste for a ceramic green sheet containing a polyvinyl acetal resin, an organic solvent, and ceramic powder, wherein the polyvinyl acetal resin is acetalized by adding at least dialdehyde at a proportion of from 0.005 to 2 mol % to a vinyl alcohol unit of polyvinyl alcohol having a degree of saponification of 80 mol % or more.

Patent Reference No. 2 describes a slurry composition for a ceramic green sheet containing: a polyvinyl acetal resin having a degree of polymerization of over 1000 and not more than 4500, obtained by acetalization of a polyvinyl alcohol resin having a vinyl ester unit content of less than 1 mol % with monoaldehyde, and having a degree of acetalization of from 60 to 83 mol %; ceramic powder; and an organic solvent.

Patent Reference No. 3 describes a method of producing a stacked ceramic component including a step of preparing a plurality of green sheets containing ceramic powder and an organic binder as essential components, a step of forming a conductor layer on a surface of at least part of the plurality of green sheets, and a step of sintering the plurality of green sheets in lamination, wherein a surface of a lamination obtained by laminating the plurality of green sheets is subjected to surface treatment with ozone followed by lamination of a green sheet on the treated surface.

Patent Reference No. 4 describes a method of producing a lamination using a film surface modified by an atmospheric pressure plasma device, a lamination, and a packaging container using the same.

However, the ceramic paste and the slurry composition according to Patent Reference Nos. 1 and 2 sometimes have insufficient storage stability. In addition, there may be a large amount of carbon residue in shaped ceramic articles obtained from them, and the shaped articles may have insufficient electrical properties and the like. Patent Reference No. 3 refers to a production method to improve adhesiveness by surface treatment on a green sheet surface with ozone and Patent Reference No. 4 refers to a production method to improve adhesiveness by surface treatment on a film using an atmospheric plasma device, whereas both refer only to the improvement in adhesiveness and do not refer to storage stability of a slurry and an amount of carbon residue for quality improvement of the shaped article.

Meanwhile, polyvinyl acetal is also used as a binder for a conductive paste that is used for manufacture of a stacked ceramic capacitor and the like. The stacked ceramic capacitor is a chip type ceramic capacitor in which a large number of dielectrics, such as titanium oxide and barium titanate, and internal electrodes are stacked. Such stacked ceramic capacitor may be manufactured in, for example, the following method. Examples include a method in which a plurality of conductive pastes to be internal electrodes applied on surfaces of ceramic green sheets by screen printing and the like are stacked and heat pressure bonded to obtain a lamination, followed by heating of the lamination for decomposition removal of the binder and then sintering.

Examples of the performances required for a binder for a conductive paste include excellent storage stability, good adhesiveness between the conductive paste and the green sheets, and a less amount of carbon residue in a produced sintered body. When the storage stability of the conductive paste is insufficient, the printability becomes worse during printing of a conductive paste on the surface of a ceramic green sheet and the smoothness of the printing surface becomes poor. When there is a large amount of carbon residue, the sintered body has insufficient electrical properties and the like.

Patent Reference No. 5 describes a binder resin for a conductive paste containing a polyvinyl acetal-(meth)acrylic acid ester composite resin obtained by adding a polymerizable monomer having (meth)acrylic acid esters as a main component to an aqueous medium having a polyvinyl acetal resin dispersed therein for permeation in the polyvinyl acetal resin, followed by polymerization.

However, a conductive paste using the binder for a conductive paste according to Patent Reference No. 5 has insufficient storage stability. In addition, there is a large amount of carbon residue in the sintered body thus produced and the performances are insufficient. Patent Reference No. 3 describes a method production to improve adhesiveness by surface treatment to a green sheet surface with ozone and Patent Reference No. 4 describes a production method to improve adhesiveness by surface treatment to a film using an atmospheric plasma device, whereas both refer only to the improvement in adhesiveness and do not refer to storage stability of a conductive paste and an amount of carbon residue for quality improvement of the shaped article.

### PRIOR ART REFERENCES

### Patent References

Patent Reference No. 1: JP 2006-282490 A

Patent Reference No. 2: WO 2011/092963 A1

Patent Reference No. 3: JP 2003-95750 A

Patent Reference No. 4: WO 2011/046143 A1

Patent Reference No. 5: JP 2005-15654 A

### SUMMARY OF THE INVENTION

### Problems to be Solved by the Invention

The present invention has been made to solve the above problems, and it is an object thereof to provide a binder for ceramic formation that is capable of obtaining a ceramic slurry excellent in storage stability and also has a less amount of carbon residue after sintering and improved adhesiveness.

It is an object of the present invention to provide a binder for a conductive paste that is capable of obtaining a conductive paste excellent in storage stability and improving adhesiveness during pressure bonding of a lamination and also capable of obtaining a sintered body having a less amount of carbon residue.

### Means for Solving the Problems

The above problems can be solved by providing a binder for ceramic formation or a conductive paste, comprising

polyvinyl acetal having a degree of acetalization of from 50 to 85 mol %, a content of vinyl ester monomer unit of from 0.1 to 20 mol %, and having a viscosity-average degree of polymerization of from 200 to 5000, wherein

a peak-top molecular weight (A) as measured by a differential refractive index detector and a peak-top molecular weight (B) as measured by an absorptiometer (measurement wavelength: 280 nm) in gel permeation chromatographic measurement of the polyvinyl acetal heated at 230° C. for 3 hours satisfy a formula (1) below

(A−B)/A<0.60 (1)

and the polyvinyl acetal has an absorbance in the peak-top molecular weight (B) of from 0.50×10⁻³ to 1.00×10⁻²

Here, in the GPC measurement,

Mobile phase: hexafluoroisopropanol with 20 mmol/L sodium trifluoroacetate (hereinafter, hexafluoroisopropanol is sometimes abbreviated as HFIP)

Sample concentration: 1.00 mg/mL

Sample injection volume: 100 μL

Column: “GPC HFIP-806M” manufactured by Showa Denko K. K.

Column temperature: 40° C.

Flow rate: 1 mL/min.

Cell Length of Absorptiometer: 10 mm.

In this case, it is preferred that the polyvinyl acetal has a ratio Mw/Mn of a weight-average molecular weight Mw to a number-average molecular weight Mn as measured by the differential refractive index detector in the gel permeation chromatographic measurement of from 2.8 to 12.0.

It is preferred that the polyvinyl acetal is polyvinyl butyral. It is also preferred that the polyvinyl acetal has, in a side chain, at least one functional group selected from the group consisting of an amide group, an amino group, ester group, a carbonyl group, and a vinyl group. It is also preferred that the functional group is an amide group or an amino group.

It is preferred that the above binder is the binder for ceramic formation.

A preferred embodiment of the present invention is a ceramic slurry comprising: the binder for ceramic formation; ceramic powder; an organic solvent; and a plasticizer. A ceramic green sheet obtained by using the ceramic slurry is also a preferred embodiment of the present invention.

The above problems can also be solved by providing a method of producing a ceramic green sheet, comprising applying atmospheric pressure plasma treatment on at least one surface of the ceramic green sheet.

The above problems can also be solved by providing a ceramic green sheet obtained by the production method.

It is preferred that the binder is the binder for a conductive paste.

A preferred embodiment of the present invention is a conductive paste comprising: the binder for a conductive paste; metal powder; and an organic solvent. A coated sheet obtained by coating the conductive paste on a surface of a ceramic green sheet is also a preferred embodiment of the present invention.

The above problems can also be solved by providing a method of producing a coated sheet, comprising applying atmospheric pressure plasma treatment on at least one surface of the coated sheet.

The above problems can also be solved by providing a coated sheet obtained by the production method.

### Effects of the Invention

A ceramic slurry obtained by using a binder for ceramic formation of the present invention is excellent in storage stability. In addition, a binder of the present invention has a less amount of carbon residue after sintering.

A conductive paste obtained by using a binder for a conductive paste of the present invention is excellent in storage stability. In addition, adhesiveness during pressure bonding of a lamination is improved and further the use of the conductive paste enables production of a sintered body having a less amount of carbon residue.

### BRIEF DESCRIPTION OF THE DRAWINGS

FIG. 1 is a graph showing relationship between a molecular weight and a value as measured by a differential refractive index detector (RI), and relationship between a molecular weight and an absorbance as measured by an absorptiometer (UV) (measurement wavelength: 280 nm) for polyvinyl acetal in Example 1.

### MODES FOR CARRYING OUT THE INVENTION

Polyvinyl acetal contained in a binder for ceramic formation or a conductive paste of the present invention is polyvinyl acetal having a degree of acetalization of from 50 to 85 mol %, a content of vinyl ester monomer unit of from 0.1 to 20 mol %, and having a viscosity-average degree of polymerization of from 200 to 5000, wherein

a peak-top molecular weight (A) as measured by a differential refractive index detector and a peak-top molecular weight (B) as measured by an absorptiometer (measurement wavelength: 280 nm) in GPC measurement of the polyvinyl acetal heated at 230° C. for 3 hours satisfy a formula (1) below

(A−B)/A<0.60 (1)

and the polyvinyl acetal has an absorbance in the peak-top molecular weight (B) of from 0.50×10⁻³ to 1.00×10⁻².

Here, in the GPC measurement,

Mobile phase: HFIP with 20 mmol/L sodium trifluoroacetate

Sample concentration: 1.00 mg/mL

Sample injection volume: 100 μL

Column: “GPC HFIP-806M” manufactured by Showa Denko K. K.

Column temperature: 40° C.

Flow rate: 1 mL/min.

Cell Length of Absorptiometer: 10 mm.

In the present invention, GPC measurement is conducted using a GPC instrument equipped with a differential refractive index detector and an absorptiometer, which permits concurrent measurement using these detectors. An absorptiometer is used that is capable of measuring the absorbance at a wavelength of 280 nm. A cell in a detection unit in the absorptiometer has a cell length (optical path length) of 10 mm. The absorptiometer may be a type which measures absorption of ultraviolet light with a particular wavelength or a type which spectrometrically measures ultraviolet light absorption having a wavelength within a particular range. Polyvinyl acetal to be measured is separated into individual molecular weight components by a GPC column. Signal intensity as measured by a differential refractive index detector is generally proportional to a concentration of polyvinyl acetal (mg/mL). Meanwhile, polyvinyl acetal detected by an absorptiometer is only one that can absorb a given wavelength. For each molecular weight component in the polyvinyl acetal, a concentration and an absorbance at a given wavelength can be measured by the GPC measurement described above.

A solvent and a mobile phase used for dissolving polyvinyl acetal measured in the above GPC measurement is HFIP with 20 mmol/L sodium trifluoroacetate. HFIP can dissolve polyvinyl acetal and polymethyl methacrylate (hereinafter, may be abbreviated as PMMA). Furthermore, addition of sodium trifluoroacetate allows inhibition of adsorption of polyvinyl acetal to a column filler. In the GPC measurement, a flow rate is 1 mL/min and a column temperature is 40° C.

In the GPC measurement, monodisperse PMMA (hereinafter, referred to as standard PMMA) is used as a standard. Measurement is conducted for several types of standard PMMA with a different molecular weight, and from GPC elution volumes and molecular weights of the standard PMMA, a calibration curve is formed. Herein, for measurement by a differential refractive index detector, a calibration curve formed using the detector is used, while for measurement by an absorptiometer, a calibration curve formed using the detector is used. Using these calibration curves, a GPC elution volume is converted to a molecular weight, and a peak-top molecular weight (A) and a peak-top molecular weight (B) are determined.

Before the above GPC measurement, polyvinyl acetal is heated at 230° C. for 3 hours. Herein, polyvinyl acetal is heated by the following method. In order to clearly reflect a difference in sample hue after heating on a difference in an absorbance, polyvinyl acetal powder is hot pressed at a pressure of 2 MPa and a temperature of 230° C. for 3 hours to obtain heated polyvinyl acetal (film). A thickness of the film at this point is from 600 to 800 μm, preferably 760 μm in general.

After heating, the polyvinyl acetal is dissolved in the above solvent to prepare a measurement sample. A concentration of polyvinyl acetal in the measurement sample is 1.00 mg/mL and an injection volume is 100 μL. Here, if a viscosity-average degree of polymerization of the polyvinyl acetal is over 2400, an excluded volume is so increased that at a concentration of the polyvinyl acetal of 1.00 mg/mL, measurement may not be reproducibly conducted. In such a case, an appropriately diluted sample (injection volume: 100 μL) is used. An absorbance is proportional to a concentration of polyvinyl acetal. Therefore, using a concentration of a diluted sample and the observed absorbance, an absorbance is obtained at polyvinyl acetal concentration of 1.00 mg/mL.

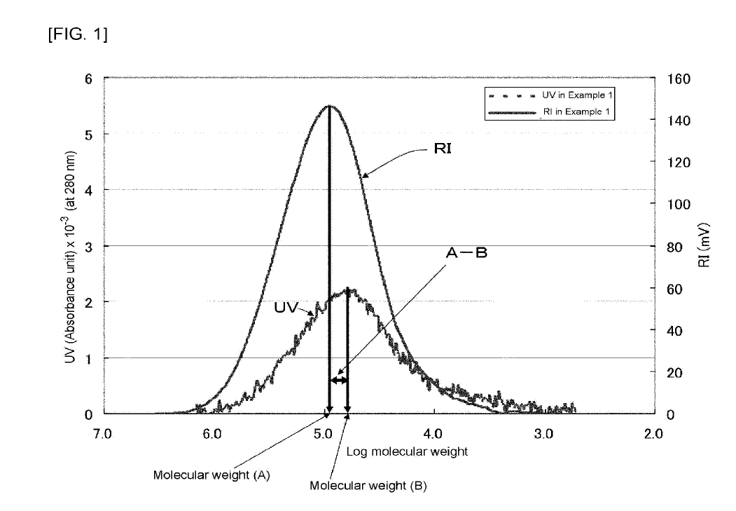

FIG. 1 is a graph showing relationship between a molecular weight and a value as measured by a differential refractive index detector, and relationship between a molecular weight and an absorbance as measured by an absorptiometer (measurement wavelength: 280 nm), which were obtained by GPC measurement of polyvinyl acetal in Examples of the present invention described later. Using FIG. 1, there will be further described GPC measurement in the present invention. In FIG. 1, the chromatogram indicated by “RI” is a plot of a value as measured by a differential refractive index detector to a molecular weight of polyvinyl acetal converted from an elution volume (horizontal axis). Herein, a molecular weight at such a peak position in the chromatogram is a peak-top molecular weight (A). When a plurality of peaks is present in the chromatogram, a molecular weight at the highest peak is regarded as a peak-top molecular weight (A).

In FIG. 1, the chromatogram indicated by “UV” is a plot of an absorbance as measured by an absorptiometer (measurement wavelength: 280 nm) to a molecular weight of polyvinyl acetal converted from an elution volume (horizontal axis). Herein, a molecular weight at a peak position in the chromatogram is a peak-top molecular weight (B). When a plurality of peaks is present in the chromatogram, a molecular weight at the highest peak is regarded as a peak-top molecular weight (B).

In the polyvinyl acetal, the following formula (1) is satisfied by a peak-top molecular weight (A) as measured by a differential refractive index detector and a peak-top molecular weight (B) as measured by an absorptiometer (measurement wavelength: 280 nm), obtained by GPC measurement as described above.

(A−B)/A<0.60 (1)

A peak-top molecular weight (A) is a measure of a molecular weight of polyvinyl acetal. Meanwhile, a peak-top molecular weight (B) is derived from a component having absorption at 280 nm which is present in polyvinyl acetal. A peak-top molecular weight (A) is generally larger than a peak-top molecular weight (B), so that (A−B)/A is positive. The larger a peak-top molecular weight (B) is, the smaller (A−B)/A is, while the smaller a peak-top molecular weight (B) is, the larger (A−B)/A is. It indicates that a larger (A−B)/A means more components absorbing ultraviolet rays with a wavelength of 280 nm in low molecular weight components in polyvinyl acetal.

If (A−B)/A is 0.60 or more, more components absorbing ultraviolet rays with a wavelength of 280 nm are present in low molecular weight components as described above.

If (A−B)/A is 0.60 or more, the storage stability of a ceramic slurry containing the polyvinyl acetal is reduced. (A−B)/A is preferably less than 0.55 and more preferably less than 0.50.

If (A−B)/A is 0.60 or more, the storage stability of a conductive paste containing the polyvinyl acetal is reduced. (A−B)/A is preferably less than 0.55 and more preferably less than 0.50.

The polyvinyl acetal has to have an absorbance in the peak-top molecular weight (B) in GPC measurement by the method described above (measurement wavelength: 280 nm) of from 0.50×10⁻³ to 1.00×10⁻².

If the absorbance is less than 0.50×10⁻³, the dispersibility of a ceramic slurry containing the polyvinyl acetal is reduced. In addition, the storage stability of the ceramic slurry is also reduced. In contrast, if the absorbance is over 1.00×10⁻², an amount of carbon residue in a shaped ceramic article produced therefrom increases. The absorbance is preferably from 1.00×10⁻³ to 8.00×10⁻³ and more preferably from 1.50×10⁻³ to 6.50×10⁻³.

If the absorbance is less than 0.50×10⁻³, the storage stability of a conductive paste obtained therefrom is reduced. In addition, the dispersibility of metal powder in the conductive paste is also reduced. In contrast, if the absorbance is over 1.00×10⁻², an amount of carbon residue after heating of the conductive paste increases and electrical properties and the like of a sintered body obtained therefrom are insufficient. The absorbance is preferably from 1.00×10⁻³ to 8.00×10⁻³ and more preferably from 1.50×10⁻³ to 6.50×10⁻³.

It is preferred that the polyvinyl acetal has a ratio Mw/Mn of a weight-average molecular weight Mw to a number-average molecular weight Mn as measured by the differential refractive index detector in the GPC measurement of from 2.8 to 12.0. Mw and Mn are determined from the chromatogram obtained by plotting values as measured by a differential refractive index detector to the molecular weight of polyvinyl acetal described above. Mw and Mn in the present invention are values converted to PMMA.

Generally, Mn is an average molecular weight strongly affected by low molecular weight components, and Mw is an average molecular weight strongly affected by high molecular weight components. Mw/Mn is generally used as an index for molecular weight distribution of a polymer. A smaller Mw/Mn indicates a polymer having a smaller proportion of low molecular weight components, and a larger Mw/Mn indicates a polymer having a large proportion of low molecular weight components.

Accordingly, in the present invention, Mw/Mn less than 2.8 indicates a smaller proportion of low molecular weight components in polyvinyl acetal.

If Mw/Mn is less than 2.8, the dispersibility of a ceramic slurry containing the polyvinyl acetal may be reduced. The storage stability of the ceramic slurry may also be reduced. Mw/Mn is more preferably 2.9 or more and even more preferably 3.1 or more. In contrast, Mw/Mn over 12.0 indicates a large proportion of low molecular weight components in polyvinyl acetal. If Mw/Mn is over 12.0, an amount of carbon residue in a shaped ceramic article produced therefrom may increase. Mw/Mn is more preferably 11.0 or less and even more preferably 8.0 or less.

When the dispersibility and the storage stability of the ceramic slurry is reduced, the green sheet surface is roughened and it is considered to adversely affect the adhesiveness of the green sheet and quality of a shaped article produced after that and quality after sintering.

If Mw/Mn is less than 2.8, the dispersibility of metal powder in the conductive paste may be reduced. The storage stability of the conductive paste may also be reduced. Mw/Mn is more preferably 2.9 or more and even more preferably 3.1 or more. In contrast, Mw/Mn over 12.0 indicates a larger proportion of low molecular weight components in polyvinyl acetal. If Mw/Mn is over 12.0, an amount of carbon residue after heating of the conductive paste increases and electrical properties and the like of a sintered body obtained therefrom may be insufficient. Mw/Mn is more preferably 11.0 or less and even more preferably 8.0 or less.

When the storage stability of the conductive paste is reduced, a desired printing thickness may not be obtained, the surface after printing may be rough to adversely affect the electrical properties and the like of the sintered body.

A degree of acetalization of polyvinyl acetal contained in a binder of the present invention is from 55 to 80 mol %, preferably from 55 to 82 mol %, more preferably from 60 to 78 mol %, and even more preferably from 65 to 75 mol %.

If a degree of acetalization is less than 50 mol %, the storage stability of a ceramic slurry containing the polyvinyl acetal is reduced. Meanwhile, if the degree of acetalization is more than 85 mol %, efficiency of an acetalization reaction is significantly reduced. In addition, the hydroxyl group (vinyl alcohol monomer unit) content in polyvinyl acetal is reduced, and the strength of a ceramic green sheet produced by using a binder for ceramic formation of the present invention is reduced. Further, an amount of carbon residue in a shaped ceramic article produced therefrom increases.

If the degree of acetalization is less than 50 mol %, the storage stability of a conductive paste containing the polyvinyl acetal is reduced. In contrast, if the degree of acetalization is over 85 mol %, the efficiency of acetalization reaction is significantly reduced and the productivity is significantly worsened, and thus it lacks commerciality. An amount of carbon residue after heating of the conductive paste increases, and electrical properties and the like of a sintered body obtained therefrom are insufficient.

A degree of acetalization is a proportion of acetalized vinyl alcohol monomer units to the total monomer units constituting polyvinyl acetal. Of vinyl alcohol monomer units in starting PVA, those which have not been acetalized remain as vinyl alcohol monomer units in polyvinyl acetal produced.

A viscosity-average degree of polymerization of polyvinyl acetal contained in a binder of the present invention is expressed as a viscosity-average degree of polymerization of starting PVA measured in accordance with JIS-K6726. Specifically, PVA is resaponified to a degree of saponification of 99.5 mol % or more and purified, followed by measuring its limiting viscosity [η] (l/g) in water at 30° C., which can be used for determining a viscosity-average degree of polymerization from the equation below. A viscosity-average degree of polymerization of PVA is substantially equal to a viscosity-average degree of polymerization of polyvinyl acetal as its acetalization product.

P=([η]10000/8.29)^{(1/0.62)}

The polyvinyl acetal has a viscosity-average degree of polymerization of from 200 to 5000.

If the viscosity-average degree of polymerization is less than 200, the strength of a ceramic green sheet produced by using the binder for ceramic formation of the present invention may be reduced. The viscosity-average degree of polymerization is preferably 250 or more, more preferably 300 or more, and even more preferably 400 or more. In contrast, if the viscosity-average degree of polymerization is over 5000, the viscosity of a ceramic slurry prepared during production of a ceramic green sheet becomes too high and the productivity may be reduced. The viscosity-average degree of polymerization is preferably 4500 or less, more preferably 4000 or less, and even more preferably 3500 or less.

If the viscosity-average degree of polymerization is less than 200, when a coating film is formed by coating a conductive paste of the present invention, the strength of the coating film may be reduced. The viscosity-average degree of polymerization is preferably 250 or more, more preferably 300 or more, and even more preferably 400 or more. In contrast, if the viscosity-average degree of polymerization is over 5000, the viscosity of the conductive paste becomes too high and the printability may be reduced. The viscosity-average degree of polymerization is preferably 4500 or less, more preferably 4000 or less, even more preferably 3500 or less, and particularly preferably 2500 or less.

A content of vinyl ester monomer unit in the polyvinyl acetal is from 0.1 to 20 mol %, preferably from 0.3 to 18 mol %, more preferably from 0.5 to 15 mol %, and even more preferably from 0.7 to 13 mol %. If a content of vinyl ester monomer unit is less than 0.1 mol %, polyvinyl acetal cannot be stably produced.

If the content of vinyl ester monomer unit is over 20 mol %, the storage stability of a ceramic slurry containing the polyvinyl acetal is reduced and also an amount of carbon residue in a shaped ceramic article produced therefrom increases.

If the content of vinyl ester monomer unit is over 20 mol %, the storage stability of a conductive paste containing the polyvinyl acetal is reduced.

A content of monomer units other than acetalized monomer units, vinyl ester monomer units, and vinyl alcohol monomer units in the polyvinyl acetal is preferably 20 mol % or less and more preferably 10 mol % or less.

Polyvinyl acetal contained in a binder of the present invention is generally produced by acetalizing PVA.

A degree of saponification of starting PVA is preferably from 80 to 99.9 mol %, more preferably from 82 to 99.7 mol %, even more preferably from 85 to 99.5 mol %, and most preferably from 87 to 99.3 mol %.

If the degree of saponification is less than 80 mol %, the dispersibility of a ceramic slurry containing the polyvinyl acetal may be reduced.

If the degree of saponification is less than 80 mol %, the dispersibility of metal powder in the conductive paste may be reduced. In addition, the storage stability of a conductive paste containing the polyvinyl acetal is reduced.

Meanwhile, if the degree of saponification is more than 99.9 mol %, PVA may not be stably produced. A degree of saponification of PVA is measured in accordance with JIS-K6726.

The polyvinyl acetal preferably has at least one functional group selected from the group consisting of an amide group, an amino group, an ester group, a carbonyl group, and a vinyl group in a side chain. The functional group is more preferably an amide group or an amino group. Its content based on the number of monomer units in PVA before acetalization is preferably 20 mol % or less, more preferably 10 mol % or less, and even more preferably 5 mol % or less. If the functional group content is less than 20 mol %, production of polyvinyl acetal sometimes becomes difficult.

The process of introducing a functional group into a side chain is not particularly limited. In, for example, a production method described later, examples of the process include a method in which a comonomer having the functional group and vinyl ester, such as vinyl acetate, are copolymerized, a method in which acetalization is performed using aldehyde having the functional group, a method in which hydroxyl groups in vinyl alcohol units that have not been acetalized are reacted with carboxylic acid, and the like. Examples of the polymerization method include known methods, such as bulk polymerization, solution polymerization, suspension polymerization, and emulsion polymerization. Among these methods, bulk polymerization in a nonsolvent system or solution polymerization using a solvent, such as alcohol, are employed generally. From the perspective of improving the effects of the present invention, solution polymerization is preferred in which polymerization is conducted together with lower alcohol.

Examples of vinyl ester which is used for producing starting PVA include vinyl formate, vinyl acetate, vinyl propionate, vinyl valerate, vinyl caprate, vinyl laurate, vinyl stearate, vinyl benzoate, vinyl pivalate, and vinyl versatate, particularly preferably vinyl acetate.

Examples of the comonomer that is used in the copolymerization with vinyl acetate and may be copolymerized to introduce the functional group include a carbonyl group-containing monomer, an amino group-containing monomer, a vinyl group-containing monomer, an N-vinylamide based monomer, and a (meth)acrylamide based monomer, and the like.

Examples of the carbonyl group-containing monomer include diacetone acrylamide and the like.

Examples of the amino group-containing monomer include allylamine, dimethylaminopropyl methacrylamide, N-isobutoxymethyl methacrylamide, dimethylaminoacrylamide, dimethylaminoethyl acrylate, acryloylmorpholine, and the like. Examples of the vinyl group-containing monomer include trimethylolpropane diallyl ether, pentaerythritol triallyl ether, and the like.

Examples of the N-vinylamide based monomer include N-vinyl-2-pyrrolidones, N-vinyl-2-caprolactams, N-vinylformamide, N-methyl-N-vinylformamide, N-vinylacetoamide, N-methyl-N-vinylacetoamide, and the like.

Examples of N-vinyl-2-pyrrolidones include N-vinyl-2-pyrrolidone, N-vinyl-3-propyl-2-pyrrolidone, N-vinyl-5,5-dimethyl-2-pyrrolidone, N-vinyl-3,5-dimethyl-2-pyrrolidone, and the like.

Examples of the (meth)acrylamide based monomer include: acrylamide; acrylamide derivatives such as N-methylacrylamide and N-ethylacrylamide; methacrylamide; methacrylamide derivatives such as N-methylmethacrylamide and N-ethylmethacrylamide; and the like.

Examples of the acrylamide derivatives include N-methylolacrylamide, N-methoxymethylacrylamide, N-n-butoxymethylacrylamide, n-isobutoxymethylacrylamide, tertiary butylacrylamidesulfonic acid, tertiary butylacrylamide, dimethylaminopropyl methacrylamide, N-methoxymethyl methacrylamide, N-ethoxymethyl methacrylamide, N-n-butoxymethyl methacrylamide, N-isobutoxymethyl methacrylamide, N-ethoxymethyl acrylamide, and the like.

Among these monomers, from the perspective of producing a homogeneous ceramics green sheet and the perspective of producing a homogeneous coated sheet, N-vinylacetoamide, N-vinyl-2-caprolactam, N-methoxymethyl methacrylamide are even more preferred.

Starting PVA can also be produced by polymerizing vinyl ester in the presence of a thiol compound such as 2-mercaptoethanol, n-dodecyl mercaptan, mercaptoacetic acid, and 3-mercaptopropionic acid to give polyvinyl ester and then saponifying the polyvinyl ester. This process provides PVA having terminal functional groups derived from the thiol compound.

Vinyl ester can be polymerized by a known method such as bulk polymerization, solution polymerization, suspension polymerization, and emulsion polymerization. Among these, bulk polymerization in a nonsolvent system and solution polymerization using a solvent such as alcohol are generally employed. In the light of improving the effects of the present invention, solution polymerization where polymerization is conducted in lower alcohol is preferable. The lower alcohol is preferably, but not limited to, alcohol having 3 or less carbon atoms such as methanol, ethanol, propanol and isopropanol, and generally, methanol is used. When the polymerization reaction is conducted by bulk polymerization or solution polymerization, the reaction can be any of batch and continuous types. Examples of an initiator used in the polymerization reaction include known initiators including an azo initiator such as 2,2′-azobisisobutyronitrile, 2,2′-azobis(2,4-dimethylvaleronitrile), and 2,2′-azobis(4-methoxy-2,4-dimethylvaleronitrile); and organic peroxide initiator such as benzoyl peroxide, n-propyl peroxycarbonate, and peroxydicarbonate as long as the effects of the present invention are not impaired. In particular, organic peroxide initiator which has a half-life period of from 10 to 110 min. at 60° C. is preferably used, particularly preferably peroxydicarbonate. A polymerization temperature during the polymerization reaction is suitably, but not limited to, from 5 to 200° C.

In radical polymerization of vinyl ester, as necessary, copolymerization can be conducted with a copolymerizable monomer as long as the effects of the present invention are not impaired. Examples of such a monomer include α-olefins such as ethylene, propylene, 1-butene, isobutene, and 1-hexene; carboxylic acids or derivatives thereof such as fumaric acid, maleic acid, itaconic acid, maleic anhydride, and itaconic anhydride; acrylic acids or salts thereof; acrylic acid esters such as methyl acrylate, ethyl acrylate, n-propyl acrylate, and isopropyl acrylate; methacrylic acids or salts thereof; methacrylic acid esters such as methyl methacrylate, ethyl methacrylate, n-propyl methacrylate, and isopropyl methacrylate; vinyl ethers such as methyl vinyl ether, ethyl vinyl ether, n-propyl vinyl ether, isopropyl vinyl ether, and n-butyl vinyl ether; hydroxyl group-containing vinyl ethers such as ethylene glycol vinyl ether, 1,3-propanediol vinyl ether, and 1,4-butanediol vinyl ether; allyl ethers such as allyl acetate, propyl allyl ether, butyl allyl ether, and hexyl allyl ether; monomers having an oxyalkylene group; hydroxyl group-containing α-olefins such as isopropenyl acetate, 3-buten-1-ol, 4-penten-1-ol, 5-hexen-1-ol, 7-octen-1-ol, 9-decen-1-ol, and 3-methyl-3-buten-1-ol; monomers having a sulfonic group such as ethylenesulfonic acid, allylsulfonic acid, methallylsulfonic acid, and 2-acrylamide-2-methylpropanesulfonic acid; cationic group-containing monomers such as vinyloxyethyltrimethylammonium chloride, vinyloxybutyltrimethylammonium chloride, vinyloxyethyldimethylamine, vinyloxymethyldiethylamine, N-acrylamide methyltrimethylammonium chloride, N-acrylamide ethyltrimethylammonium chloride, N-acrylamide dimethylamine, allyltrimethylammonium chloride, methallyltrimethylammonium chloride, dimethylallylamine, and allylethylamine; and monomers having a silyl group such as vinyltrimethoxysilane, vinylmethyldimethoxysilane, vinyldimethylmethoxysilane, vinyltriethoxysilane, vinylmethyldiethoxysilane, vinyldimethylethoxysilane, 3-(meth)acrylamide propyltrimethoxysilane, and 3-(meth)acrylamide propyltriethoxysilane. The amounts of such a copolymerizable monomer with vinyl ester, which depend on their intended use, application and so on, are generally 20 mol % or less and preferably 10 mol % or less, based on the total monomers used in the copolymerization.

Polyvinyl ester produced by the above process can be saponified in an alcohol solvent, to give PVA.

A catalyst for saponification reaction of polyvinyl ester is generally an alkaline substance such as alkali metal hydroxides such as potassium hydroxide and sodium hydroxide; and alkali metal alkoxides such as sodium methoxide. The amount of the alkaline substance is preferably within the range from 0.002 to 0.2, particularly preferably within the range from 0.004 to 0.1, as a molar ratio based on the vinyl ester monomer unit in the polyvinyl ester. The saponification catalyst can be added in one portion at the initiation of the saponification reaction, or it can be added in part at the initiation of the saponification reaction, followed by adding the remaining part in the course of the saponification reaction.

Examples of a solvent used in the saponification reaction include methanol, methyl acetate, dimethyl sulfoxide, diethyl sulfoxide, and dimethylformamide. Among these solvents, methanol is preferably used. On this occasion, a water content of methanol is adjusted preferably from 0.001 to 1 mass %, more preferably 0.003 to 0.9 mass %, and particularly preferably 0.005 to 0.8 mass %.

The saponification reaction is conducted preferably at a temperature of from 5 to 80° C., more preferably from 20 to 70° C. The saponification reaction is conducted preferably from 5 min. to 10 hours, more preferably from 10 min to 5 hours. The saponification reaction can be conducted either in batch style or in a continuous process. After completion of the saponification reaction, the remaining catalyst can be, if necessary, neutralized. Examples of a neutralizing agent which can be used include organic acids such as acetic acid and lactic acid and ester compounds such as methyl acetate.

The alkaline substance containing alkali metal which is added in the saponification reaction is generally neutralized by ester such as methyl acetate which generates with progress of the saponification reaction, or neutralized by carboxylic acid such as acetic acid added after the reaction. Here, alkali metal salt of the carboxylic acid such as sodium acetate is formed. As described later, in the present invention, starting PVA preferably contains 0.5 mass % or less, based on the mass of the alkali metal, of alkali metal salt of carboxylic acid. To obtain such PVA, PVA after saponification can be washed.

Examples of a washing liquid used in this case include lower alcohol such as methanol, a solution containing 100 parts by mass of the lower alcohol with 20 parts by mass or less of water, and a solution containing the lower alcohol with ester such as methyl acetate which generates in the saponification process. A content of the ester in the solution containing the lower alcohol and ester is preferably, but not limited to, 1000 parts by mass or less based on 100 parts by mass of the lower alcohol. The amount of the washing liquid to be added in general is preferably from 100 parts by mass to 10000 parts by mass, more preferably from 150 parts by mass to 5000 parts by mass, and even more preferably from 200 parts by mass to 1000 parts by mass based on 100 parts by mass of gelled PVA swollen with alcohol produced by the saponification. If the amount of the washing liquid is less than 100 parts by mass, the amount of alkali metal salt of carboxylic acid may be over the above range. Meanwhile, if the amount of the washing liquid is over 10000 parts by mass, such increase of the amount does not contribute to improving washing effect. There are no particular restrictions to washing method; for example, a batch style can be employed, in which gel (PVA) and a washing liquid are charged in a chamber and stirred or left from 5 to 100° C. for about 5 min. to 180 min. and then deliquored, and the process is repeated until a content of alkali metal salt of carboxylic acid becomes within a predetermined range. Alternatively, examples of the washing method also include a continuous process can be employed, in which at the substantially same temperature and for the substantially same period as the batch style, PVA is continuously fed from a tower top while lower alcohol is continuously fed from a tower bottom to contact and mix them.

Starting PVA preferably contains alkali metal salt of carboxylic acid. Its content expressed in terms of a mass of the alkali metal is preferably 0.50 mass % or less, more preferably 0.37 mass % or less, further preferably 0.28 mass % or less, particularly preferably 0.23 mass % or less. If a content of alkali metal salt of carboxylic acid is more than 0.5 mass %, an amount of carbon residue after heating of the conductive paste increases, and electrical properties and the like of a sintered body obtained therefrom may be insufficient. A content of alkali metal salt of carboxylic acid (expressed in terms of a mass of the alkali metal) can be determined from the amount of alkali metal ion as measured by ICP emission spectrometry of an ash obtained by ashing PVA in a platinum crucible.

Alkali metal salt of carboxylic acid can be salt produced by neutralizing an alkali catalyst used in the above saponification process such as sodium hydroxide, potassium hydroxide, and sodium methylate with carboxylic acid; salt produced by neutralization of carboxylic acid in a saponification process which is added for preventing alcoholysis of starting vinyl ester such as vinyl acetate used in a process of vinyl ester polymerization described later; salt produced by neutralization of carboxylic acid having a conjugated double bond in a saponification process when the carboxylic acid is used as an inhibitor added for terminating radical polymerization; and salt intentionally added; or the like. Specific examples include, but not limited to, sodium acetate, potassium acetate, sodium propionate, potassium propionate, sodium glycerate, potassium glycerate, sodium malate, potassium malate, sodium citrate, potassium citrate, sodium lactate, potassium lactate, sodium tartate, potassium tartate, sodium salicylate, potassium salicylate, sodium malonate, potassium malonate, sodium succinate, potassium succinate, sodium maleate, potassium maleate, sodium phthalate, potassium phthalate, sodium oxalate, potassium oxalate, sodium glutarate, potassium glutarate, sodium abietate, potassium abietate, sodium sorbate, potassium sorbate, sodium 2,4,6-octatriene-1-carboxylate, potassium 2,4,6-octatriene-1-carboxylate, sodium eleostearate, potassium eleostearate, sodium 2,4,6,8-decatetraene-1-carboxylate, potassium 2,4,6,8-decatetraene-1-carboxylate, sodium retinoate, and potassium retinoate.

In the present invention, each value as determined by GPC measurement can be adjusted within the above range by, for example, using PVA produced by the following methods as a starting material for polyvinyl acetal.

A) Vinyl ester in which a radical polymerization inhibitor contained in starting vinyl ester has been preliminarily removed is used for polymerization.

B) Vinyl ester in which the total content of impurities contained in starting vinyl ester is preferably from 1 to 1200 ppm, more preferably from 3 to 1100 ppm, and even more preferably from 5 to 1000 ppm is used for radical polymerization. Examples of such impurity include aldehydes such as acetaldehyde, crotonaldehyde, and acrolein; acetals such as acetaldehyde dimethyl acetal, crotonaldehyde dimethyl acetal, and acrolein dimethyl acetal which are products of acetalization of the above aldehydes by the alcohol solvent; ketones such as acetone; and esters such as methyl acetate and ethyl acetate.

C) In a sequence of processes where starting vinyl ester is radically polymerized in an alcohol solvent and the unreacted vinyl ester is recycled, for preventing alcoholysis or hydrolysis of vinyl ester by alcohol or trace amounts of water, organic acid including hydroxycarboxylic acids such as glycolic acid, glyceric acid, malic acid, citric acid, lactic acid, tartaric acid, and salicylic acid; and polycarboxylic acids such as malonic acid, succinic acid, maleic acid, phthalic acid, oxalic acid, and glutaric acid is added for inhibiting generation of aldehyde such as acetaldehyde as a decomposition product as much as possible. The amount of such an organic acid is preferably from 1 to 500 ppm, more preferably from 3 to 300 ppm, and even more preferably from 5 to 100 ppm, based on the starting vinyl ester.

D) A solvent used for polymerization is a solvent with an impurity content of preferably from 1 to 1200 ppm, more preferably from 3 to 1100 ppm, and even more preferably from 5 to 1000 ppm in total. Impurities contained in the solvent can be those described above as impurities contained in starting vinyl ester.

E) In radical polymerization of vinyl ester, a ratio of a solvent to the vinyl ester is increased.

F) Organic peroxide is used as a radical polymerization initiator used for radical polymerization of vinyl ester. Examples of organic peroxide include acetyl peroxide, isobutyl peroxide, diisopropyl peroxycarbonate, diallyl peroxydicarbonate, di-n-propyl peroxydicarbonate, dimyristyl peroxydicarbonate, di(2-ethoxyethyl) peroxydicarbonate, di(2-ethylhexyl) peroxydicarbonate, di(methoxyisopropyl) peroxydicarbonate, and di(4-tert-butylcyclohexyl) peroxydicarbonate. In particular, a peroxydicarbonate with a half life of from 10 to 110 min. at 60° C. is preferably used.

G) When an inhibitor is added for inhibiting polymerization after radical polymerization of vinyl ester, the inhibitor is added in an amount of 5 molar equivalents or less to the remaining undecomposed radical polymerization initiator. The inhibitor can be a compound having a conjugated double bond with a molecular weight of 1000 or less which can stabilize a radical for inhibiting polymerization reaction. Specific examples include polyenes including conjugated dienes having a conjugation structure of two carbon-carbon double bonds such as isoprene, 2,3-dimethyl-1,3-butadiene, 2,3-diethyl-1,3-butadiene, 2-t-butyl-1,3-butadiene, 1,3-pentadiene, 2,3-dimethyl-1,3-pentadiene, 2,4-dimethyl-1,3-pentadiene, 3,4-dimethyl-1,3-pentadiene, 3-ethyl-1,3-pentadiene, 2-methyl-1,3-pentadiene, 3-methyl-1,3-pentadiene, 4-methyl-1,3-pentadiene, 1,3-hexadiene, 2,4-hexadiene, 2,5-dimethyl-2,4-hexadiene, 1,3-octadiene, 1,3-cyclopentadiene, 1,3-cyclohexadiene, 1-methoxy-1,3-butadiene, 2-methoxy-1,3-butadiene, 1-ethoxy-1,3-butadiene, 2-ethoxy-1,3-butadiene, 2-nitro-1,3-butadiene, chloroprene, 1-chloro-1,3-butadiene, 1-bromo-1,3-butadiene, 2-bromo-1,3-butadiene, fulvene, tropone, ocimene, phellandrene, myrcene, farnecene, cembrene, sorbic acid, sorbic acid ester, sorbic acid salt, and abietic acid; conjugated trienes having a conjugation structure of three carbon-carbon double bonds such as 1,3,5-hexatriene, 2,4,6-octatriene-1-carboxylic acid, eleostearic acid, tung oil, and cholecalciferol; conjugated polyenes having a conjugation structure of four or more carbon-carbon double bonds such as cyclooctatetraene, 2,4,6,8-decatetraene-1-carboxylic acid, retinol, and retinoic acid. Here, for compounds having a plurality of stereoisomers such as 1,3-pentadiene, myrcene and farnesene, all of the stereoisomers can be used. Further examples include aromatic compounds such as p-benzoquinone, hydroquinone, hydroquinone monomethyl ether, 2-phenyl-1-propene, 2-phenyl-1-butene, 2,4-diphenyl-4-methyl-1-pentene, 3,5-diphenyl-5-methyl-2-heptene, 2,4,6-triphenyl-4,6-dimethyl-1-heptene, 3,5,7-triphenyl-5-ethyl-7-methyl-2-nonene, 1,3-diphenyl-1-butene, 2,4-diphenyl-4-methyl-2-pentene, 3,5-diphenyl-5-methyl-3-heptene, 1,3,5-triphenyl-1-hexene, 2,4,6-triphenyl-4,6-dimethyl-2-heptene, 3,5,7-triphenyl-5-ethyl-7-methyl-3-nonene, 1-phenyl-1,3-butadiene, and 1,4-diphenyl-1,3-butadiene.

H) Saponification reaction is conducted using an alcohol solution of polyvinyl ester in which remaining vinyl ester has been removed as much as possible. Polyvinyl ester with a residual monomer removal rate of preferably 99% or more, more preferably 99.5% or more, and even more preferably 99.8% or more, is used.

Polyvinyl acetal in the present invention is preferably prepared by acetalizing PVA produced by appropriately combining from A) to H) above.

The acetalization of PVA can be conducted in, for example, but not limited to, reaction conditions as follows. PVA is heated from 80 to 100° C. to be dissolved in water and then is gradually cooled taking from 10 to 60 min., to give a 3-40 mass % aqueous PVA solution. At the time when the temperature is lowered to −10 to 30° C., aldehyde and an acid catalyst are added to the aqueous solution. Maintaining the solution at a certain temperature, acetalization reaction is carried out for 30 to 300 min. During the reaction, polyvinyl acetal whose degree of acetalization has reached a certain level is deposited. Then, the reaction solution is heated to 25 to 80° C. taking from 30 to 300 min., and the temperature is maintained for 10 min. to 24 hours (this temperature is referred to as a reaction temperature in the last stage). Subsequently, a neutralizing agent such as alkali is, if necessary, added to the reaction solution to neutralize the acid catalyst, and then a deposit obtained is washed with water and dried to give polyvinyl acetal.

Generally, in such reaction or processing, agglomerated particles of polyvinyl acetal generate, so that coarse particles tend to be formed. Generation of such coarse particles may cause variation between batches. In contrast, when PVA produced using the given method described above is used as a starting material, generation of coarse particles is suppressed in comparison with a conventional product.

There are no particular restrictions to an acid catalyst used for the acetalization reaction, and any organic or inorganic acid can be used. Examples include acetic acid, para-toluenesulfonic acid, nitric acid, sulfuric acid, and hydrochloric acid. Among these, hydrochloric acid, sulfuric acid, and nitric acid can be preferably used. When nitric acid is used, the acetalization reaction is generally accelerated so that productivity can be improved, while particles of polyvinyl acetal obtained tend to be coarse, leading to increase in variation between batches. In contrast, when PVA produced using the above given method is used as a starting material, generation of coarse particles is suppressed.

Examples of aldehyde used for the acetalization reaction in the present invention include, but not limited to, aldehyde having a known hydrocarbon group and alkyl acetal thereof. Among such aldehyde having a hydrocarbon group, examples of aliphatic aldehyde and alkyl acetal thereof include formaldehyde (including paraformaldehyde), acetaldehyde, propionaldehyde, butyraldehyde, valeraldehyde, isovaleraldehyde, hexylaldehyde, 2-ethylbutyraldehyde, pivalaldehyde, octylaldehyde, 2-ethylhexyl aldehyde, nonylaldehyde, decylaldehyde, dodecylaldehyde, and the like. Examples of alicyclic aldehyde and alkyl acetal thereof include cyclopentane aldehyde, methylcyclopentane aldehyde, dimethylcyclopentane aldehyde, cyclohexane aldehyde, methylcyclohexane aldehyde, dimethylcyclohexane aldehyde, cyclohexane acetaldehyde, and the like. Examples of cyclic unsaturated aldehyde and alkyl acetal thereof include cyclopenten aldehyde, cyclohexene aldehyde, and the like. Examples of aromatic or unsaturated bond containing aldehyde and alkyl acetal thereof include benzaldehyde, methylbenzaldehyde, dimethylbenzaldehyde, methoxybenzaldehyde, phenylacetaldehyde, phenylpropylaldehyde, cuminaldehyde, naphthylaldehyde, anthraldehyde, cinnamaldehyde, crotonaldehyde, acroleinaldehyde, 7-octen-1-al, and the like. Examples of heterocyclic aldehyde and alkyl acetal thereof include furfural aldehyde, methylfurfural aldehyde, and the like. Among such aldehyde, aldehyde having a carbon number from 1 to 8 is preferred, aldehyde having a carbon number of from 4 to 6 is more preferred, and n-butyraldehyde is used particularly preferably. In the present invention, polyvinyl acetal produced using a combination of two or more aldehydes can also be used.

In the present invention, as aldehyde used for acetalization of the polyvinyl alcohol resin (starting PVA), aldehyde having a functional group selected from an amide group, an amino group, an ester group, a carbonyl group, and a vinyl group or alkyl acetal thereof may be used. Among all, aldehyde having an amino group as the functional group is preferred.

Examples of aldehyde having an amino group as the functional group include aminoacetaldehyde, dimethylaminoacetaldehyde, diethylaminoacetaldehyde, aminopropionaldehyde, dimethylaminopropionaldehyde, aminobutyraldehyde, aminopentylaldehyde, aminobenzaldehyde, dimethylaminobenzaldehyde, ethylmethylaminobenzaldehyde, diethylaminobenzaldehyde, pyrrolidylacetaldehyde, piperidylacetaldehyde, pyridylacetaldehyde, and the like. From the perspective of productivity, aminobutyraldehyde is preferred.

Examples of aldehyde having a vinyl group as a functional group include acrolein and the like.

Examples of aldehyde having a carbonyl group as a functional group include glyoxylic acid and metal salt or ammonium salt thereof, 2-formylacetic acid and metal salt or ammonium salt thereof, 3-formylpropionic acid and metal salt or ammonium salt thereof, 5-formylpentanoic acid and metal salt or ammonium salt thereof, 4-formylphenoxyacetic acid and metal salt or ammonium salt thereof, 2-carboxybenzaldehyde and metal salt or ammonium salt thereof, 4-carboxybenzaldehyde and metal salt or ammonium salt thereof, 2,4-dicarboxybenzaldehyde and metal salt or ammonium salt thereof, and the like.

Examples of aldehyde having an ester group as a functional group include methyl glyoxylate, ethyl glyoxylate, methyl formylacetate, ethyl formylacetate, 3-methyl formylpropionate, 3-ethyl formylpropionate, 5-methyl formylpentanoate, 5-ethyl formylpentanoate, and the like.

It may also use, as long as the effects of the present invention are not impaired, heterocyclic aldehyde and alkyl acetal thereof, aldehyde having a hydroxyl group, aldehyde having a sulfonic acid group, aldehyde having a phosphoric acid group, aldehyde having a cyano group, a nitro group, quaternary ammonium salt, or the like, aldehyde having a halogen atom, and the like.

A binder of the present invention containing polyvinyl acetal thus produced is useful as a binder for ceramic formation. The binder is used suitably for a ceramic slurry and the like. The ceramic slurry produced by using the binder is excellent in dispersibility of ceramic powder and also excellent in storage stability. A ceramic green sheet produced by forming such ceramic slurry is excellent in surface smoothness. In addition, using a binder for ceramic formation of the present invention, a ceramic green sheet that is also excellent in sheet strength is produced. Further, a binder of the present invention has a less amount of carbon residue after sintering. Accordingly, using a binder of the present invention, a shaped ceramic article is produced that has a less amount of carbon residue and high performances.

The binder of the present invention may contain, without departing from the spirit of the present invention, an adhesiveness modifier, a plasticizer, and other conventionally known additives.

As the plasticizer contained in the binder for ceramic formation of the present invention, plasticizers used for production of a ceramic slurry described later may be used.

The content of the components other than the polyvinyl acetal contained in the binder for ceramic formation of the present invention is less than 50 mass %, preferably less than 20 mass %, more preferably less than 10 mass %, and even more preferably substantially not containing the components.

The amount of the binder for ceramic formation of the present invention to be used varies depending on the intended use of a green sheet and thus should not be defined unconditionally, however it is generally from 3 to 20 parts by mass based on 100 parts by mass of ceramic powder and preferably from 5 to 15 parts by mass.

When ceramic powder is formed using the binder for ceramic formation of the present invention, it is preferred to use a ceramic slurry containing the binder for ceramic formation of the present invention, an organic solvent, and ceramic powder. Examples of a preferred method of forming ceramic powder include a so-called sheet forming technique in which the ceramic slurry is applied on a carrier film using a blade coater or the like for drying, followed by release from the carrier film to obtain a green sheet.

Although not being limited in particular, a content of the polyvinyl acetal in the ceramic slurry is preferably from 3 to 20 parts by mass based on 100 parts by mass of ceramic powder and more preferably from 5 to 15 parts by mass.

Examples of the ceramic powder include powder of oxides or non-oxides of metal or non-metal used for production of ceramic. Specific examples include oxides, carbides, nitrides, borides, sulfides, and the like of Li, K, Mg, B, Al, Si, Cu, Ca, Sr, Ba, Zn, Cd, Ga, In, Y, lanthanoid, actinoid, Ti, Zr, Hf, Bi, V, Nb, Ta, W, Mn, Fe, Co, Ni, and the like. Specific examples of oxide powder containing a plurality of metal elements, generally referred to as double oxide, classified by the crystal structure include those having a perovskite structure, such as NaNbO₃, SrZrO₃, PbZrO₃, SrTiO₃, BaZrO₃, PbTiO₃, and BaTiO₃, those having a spinel structure, such as MgAl₂O₄, ZnAl₂O₄, CoAl₂O₄, NiAl₂O₄, and MgFe₂O₄, those having an ilmenite structure, such as MgTiO₃, MnTiO₃, and FeTiO₃, those having a garnet structure, such as GdGa₅O₁₂ and Y₆Fe₅O₁₂. Such ceramic powder may be used singly or as a mixture in combination of two or more.

Although not being limited in particular, examples of the organic solvent contained in the ceramic slurry include: alcohol, such as methanol, ethanol, isopropanol, n-propanol, and butanol; Cellosolve, such as methyl cellosolve and butyl cellosolve; ketones, such as acetone and methyl ethyl ketone; aromatic hydrocarbon, such as toluene and xylene; halogen-based hydrocarbon, such as dichloromethane and chloroform; and the like. They may be used singly or in combination of two or more.

Although not being limited in particular, the content of the organic solvent in the ceramic slurry is preferably from 2 to 200 parts by mass based on 100 parts by mass of ceramic powder. If the organic solvent content is less than 2 parts by mass, the viscosity of a slurry composition for a ceramic green sheet becomes too high and the kneadability tends to be reduced. The content is more preferably 5 parts by mass or more and even more preferably 10 parts by mass or more. In contrast, if the ceramic powder content is over 200 parts by mass, the viscosity becomes too low and the handleability for forming a ceramic green sheet tends to be worse. The content is more preferably 170 parts by mass or less and even more preferably 150 parts by mass or less.

Preferably, the ceramic slurry contains a plasticizer. There are no particular restrictions to the plasticizer as long as it does not impair the effects of the present invention and it is satisfactorily compatible with polyvinyl acetal. There are no particular restrictions to the plasticizer as long as it does not impair the effects of the present invention and it is satisfactorily compatible with polyvinyl acetal. As the plasticizer, mono- or di-ester of oligoalkylene glycol having hydroxy groups at both ends with carboxylic acid, diester of dicarboxylic acid with alcohol, and the like may be used. They may be used singly or in combination of two or more. Specific examples include: mono- or di-ester of carboxylic acid carboxylate with oligoalkylene glycol having hydroxyl groups at both ends like tri- or tetra-ethylene glycol, such as triethylene glycol-di-2-ethylhexanoate, tetraethylene glycol-di-2-ethylhexanoate, triethylene glycol-di-n-heptanoate, and tetraethylene glycol-di-n-heptanoate; and diester of alcohol with dicarboxylic acid, such as dioctyl phthalate, dibutyl phthalate, dioctyl adipate, and dibutyl adipate.

When the plasticizer is added, a mass ratio of the plasticizer to the polyvinyl acetal (plasticizer/polyvinyl acetal) in the ceramic slurry is preferably from 0.01 to 2 and more preferably from 0.05 to 1.5. The content is an amount including a plasticizer preliminarily contained in the binder of the present invention.

In addition to the an organic solvent, the ceramic powder, and the polyvinyl acetal, the ceramic slurry may contain other additives such as peptizers, adhesion promoters, dispersants, tackifiers, storage stabilizers, defoaming agents, thermal decomposition promoters, antioxidants, surfactants, and lubricants. In addition, as long as not inhibiting the effects of the present invention, resins other than the polyvinyl acetal may be contained. The total amount of such other additives and other resins is preferably 50 mass % or less and more preferably 20 mass % or less.

There are no particular restrictions to a method of preparing the ceramic slurry. For example, it is possible to be produced in the following method. The binder for ceramic formation of the present invention is dissolved in an organic solvent and additives, such as a plasticizer, are added to the solution as needed, followed by stirring to produce a uniform vehicle. Ceramic powder is added to the vehicle and then dispersed uniformly to prepare a ceramic slurry. As a method of dispersion, a variety of methods may be used, such as a method using a medium disperser like a bead mill, a ball mill, an attritor, a paint shaker, and a sand mill, a stiffening method, and a method using a three roll mill. During the dispersion, an anionic dispersant having a carboxylic acid group, a maleic acid group, a sulfonic acid group, a phosphoric acid group, and the like in a molecule may be used as a dispersant. In particular, anionic dispersants not containing metal ion are used preferably.

A preferred embodiment of the present invention is a ceramic green sheet produced by using the ceramic slurry. The use of the ceramic slurry of the present invention enables preparation of a ceramic green sheet with high surface glossiness. The ceramic green sheet produced by forming ceramic powder using the binder for ceramic formation of the present invention is used preferably as a material for various electronic parts. It is used particularly preferably as a material for chip type stacked capacitors, circuit substrates for IC chip, and the like. They are produced by forming electrodes on such green sheets and stacked for pressure bonding, followed by sintering.

There are no particular restrictions to a method of producing a ceramic green sheet. Examples of the production method include a method in which the ceramic slurry is coated on a support film with one surface subjected to release treatment, followed by drying the organic solvent to form in a sheet shape. For the coating of the ceramic slurry, a roll coater, a blade coater, a die coater, a squeeze coater, a curtain coater, and the like may be used.

The support film used for production of a ceramic green sheet is preferably made from a resin that has heat resistance and solvent resistance and also has flexibility. The support film being made from a resin having flexibility enables coating of the ceramic slurry on the support film. Then, a ceramic green sheet forming film thus produced is capable of being stored in a wound state in the form of a roll to be supplied as needed.

There are no particular restrictions to the resin constituting the support film. Examples include polyester (polyethylene phthalate, etc.), polyethylene, polypropylene, polystyrene, polyimide, polyvinyl alcohol, polyvinyl chloride, fluorine containing resins such as polyfluoroethylene, nylon, cellulose, and the like. There are no particular restrictions to a thickness of the support film, and the thickness is preferably from 20 to 100 μm. The support film preferably has a surface subjected to release treatment. The release treatment applied on a surface of the support film facilitates an operation of separating the support film in a transfer step. Preferred specific examples of the support film include a silicone coated PET film.

The thickness of the ceramic green sheet varies depending on the intended use and thus should not be defined unconditionally, however it generally falls within a range between 0.1 and 300 μm. A drying temperature for drying the coating film formed on the carrier film varies depending on the thickness of the ceramic green sheet and the like and thus should not be defined unconditionally, however it generally falls within a range between 25 and 200° C.

The binder of the present invention containing the polyvinyl acetal is useful as a binder for a conductive paste.

The binder for a conductive paste containing the polyvinyl acetal may be used in combination with a polymer other than the polyvinyl acetal as long as the effects of the present invention are not impaired. Examples include acrylic polymers, cellulose-based polymers, and the like, and ethyl cellulose is particularly preferred. The content of the polymer other than the polyvinyl acetal in the binder for a conductive paste of the present invention is 50 mass % or less, preferably 10 mass % or less, more preferably 5 mass % or less, and even more preferably substantially not containing.

The content of the polyvinyl acetal in the binder for a conductive paste of the present invention is 50 mass % or more, preferably 80 mass % or more, and more preferably 90 mass %.

The binder for a conductive paste of the present invention may contain an adhesiveness modifier, a plasticizer, and other conventionally known additives without departing from the spirit of the present invention. The content of the components other than the polyvinyl acetal is 50 mass % or less, preferably 20 mass % or less, more preferably 10 mass % or less, and even more preferably substantially not containing.

A preferred embodiment of the present invention is a conductive paste containing the binder for a conductive paste, metal powder, and an organic solvent. As examples of the metal powder, not only powder of highly conductive metal, such as nickel, palladium, platinum, gold, silver, and copper, but also powder of alloy of such metal is used. They may be used singly or in combination of two or more. There are no particular restrictions to the organic solvent as long as the solvent is capable of dissolving polyvinyl acetal. Examples include: dihydroterpinyl acetate; α-terpineol; Carbitol, such as butyl carbitol; Cellosolve, such as butyl cellosolve; and the like. The organic solvent contained in the conductive paste preferably has a boiling point of 150° C. If the boiling point is less than 150° C., for example, for screen printing using the conductive paste, the organic solvent is volatilized during the printing, so that the viscosity of the conductive paste increases and may cause poor printing.

Although not being limited in particular, the content of the polyvinyl acetal in the conductive paste is preferably from 1 to 50 parts by mass based on 100 parts by mass of the metal powder. The content of the polyvinyl acetal in the conductive paste falling within such range facilitates degreasing even when sintered at low temperatures. If the content is less than 1 part by mass, film forming properties when the conductive paste is printed may be insufficient. The content is more preferably 3 parts by mass or more. In contrast, if the content is over 50 parts by mass, an amount of carbon residue in the produced sintered body may increase. The content is more preferably 25 parts by mass or less.

Although not being limited in particular, the content of the organic solvent in the conductive paste is preferably from 5 to 600 parts by mass based on 100 parts by mass of the metal powder. If the content of the organic solvent in the conductive paste is out of such range, coatability of the conductive paste may be reduced or dispersion of the metal powder may become difficult.

The conductive paste may contain, in addition to the an organic solvent, metal powder, and the polyvinyl acetal, other additives such as peptizers, plasticizers, adhesion promoters, dispersants, tackifiers, storage stabilizers, defoaming agents, thermal decomposition promoters, antioxidants, surfactants, and lubricants. In addition, as long as not inhibiting the effects of the present invention, resins other than the polyvinyl acetal may be contained. The total amount of such other additives and other resins is preferably 50 mass % or less and more preferably 20 mass % or less.

There are no particular restrictions to the plasticizer as long as it does not impair the effects of the present invention and it is satisfactorily compatible with polyvinyl acetal. There are no particular restrictions to the plasticizer as long as it does not impair the effects of the present invention and it is satisfactorily compatible with polyvinyl acetal. Examples of the plasticizer include those plasticizers listed above.

Although not being limited in particular, the adhesion promoter is preferably an aminosilane-based silane coupling agent. There are no particular restrictions to the aminosilane-based coupling agent, and examples include N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, and the like. As the adhesion promoter, it is also possible to use glycidyl silane-based silane coupling agents, such as 3-glycidoxypropyltrimethoxysilane, 3-glycidoxypropylmethyldiethoxysilane, and 3-glycidoxypropyltriethoxysilane; and other silane coupling agents, such as dimethyldimethoxysilane, tetramethoxysilane, tetraethoxysilane, phenyltrimethoxysilane, and diphenyldimethoxysilane. These adhesion promoters may be used singly or in combination of two or more.

There are no particular restrictions to a method of preparing the conductive paste. It may be produced in the following method, for example. Examples of the production method include a method in which the binder for a conductive paste, metal powder, and the organic solvent are mixed using various types of a mixer, such as a blender mill, a ball mill, and a three roll mill.

The binder for a conductive paste of the present invention is excellent in dispersibility of metal powder, and a conductive paste produced by using the binder is excellent in storage stability. It is excellent in printability for printing on a ceramic green sheet surface and the printing surface becomes smooth. The use of the conductive paste enables production of a sintered body having a less amount of carbon residue.

A preferred embodiment of the present invention is a ceramic green sheet produced by using the ceramic slurry described above. In production of a ceramic green sheet, it is preferred to include a step of applying atmospheric pressure plasma treatment on at least one surface of the ceramic green sheet. The ceramic green sheet thus obtained is also a preferred embodiment of the present invention. At least one surface of the ceramic green sheet is subjected to atmospheric pressure plasma treatment for lamination so as to contact the surface subjected to atmospheric pressure plasma treatment with a surface of another ceramic green sheet. A lamination thus obtained has good adhesiveness compared with the case of preparing a lamination using a ceramic green sheet having a surface not subjected to atmospheric pressure plasma treatment. At this point, the surface of another ceramic green sheet may be subjected to atmospheric pressure plasma treatment.

In addition, a preferred embodiment of the present invention is a coated sheet having the conductive paste described above being coated on a surface of a ceramic green sheet. In production of a coated sheet, it is preferred to include a step of applying atmospheric pressure plasma treatment on at least one surface of the coated sheet.

The surface coated with the conductive paste in the coated sheet is subjected to atmospheric pressure plasma treatment for lamination so as to contact the surface subjected to atmospheric pressure plasma treatment with a surface of another coated sheet. A lamination thus obtained exhibits good adhesiveness compared with the case of preparing a lamination using a coated sheet having a surface not subjected to atmospheric pressure plasma treatment. At this point, the surface of another coated sheet may be subjected to atmospheric pressure plasma treatment.

Here, the surface to be subjected to atmospheric pressure plasma treatment in the coated sheet may be a surface coated with the conductive paste (conductive paste surface), may be a ceramic green sheet surface, or may be both surfaces of the coated sheet. When a stacked ceramic capacitor is manufactured by stacking a plurality of coated sheets, the conductive paste surface is subjected to atmospheric pressure plasma treatment for lamination so as to contact this surface with a ceramic green sheet surface of another coated sheet. At this point, the ceramic green sheet surface of another coated sheet may be subjected to atmospheric pressure plasma treatment. A lamination thus obtained exhibits good adhesiveness. In another case, the ceramic green sheet surface is subjected to atmospheric pressure plasma treatment for lamination so as to contact this surface with a conductive paste surface of another coated sheet. At this point, the conductive paste surface of another coated sheet may be subjected to atmospheric pressure plasma treatment. A lamination thus obtained also exhibits good adhesiveness. In still another case, both surfaces of a coated sheet are subjected to atmospheric pressure plasma treatment for lamination so as to contact these surfaces with a ceramic green sheet surface or a conductive paste surface of another coated sheet. A lamination thus obtained also exhibits good adhesiveness. At this point, the ceramic green sheet surface or the conductive paste surface of another coated sheet may be subjected to atmospheric pressure plasma treatment.

### EXAMPLES

There will be further detailed the present invention with reference to Examples and Comparative Examples. In Examples and Comparative Examples below, unless otherwise indicated, “part(s)” and “%” is by mass. Here, “degree of polymerization” means “viscosity-average degree of polymerization”.

### [Synthesis of Polyvinyl Acetate]

### PVAc-1

In a 6 liter separable flask equipped with a stirrer, a thermometer, a nitrogen inlet tube, and a reflux condenser, charged were 2555 g of pre-deoxidized vinyl acetate (VAM) containing 500 ppm of acetaldehyde (AA) and 50 ppm of acetaldehyde dimethyl acetal (DMA); 945 g of methanol (MeOH) containing 50 ppm of acetaldehyde dimethyl acetal with an acetaldehyde content being less than 1 ppm; a 1% solution of tartaric acid in methanol in such an amount that a content of tartaric acid in vinyl acetate was to be 20 ppm. While nitrogen was blown into the flask, an internal temperature of the flask was adjusted to 60° C. Here, in the reflux condenser, an aqueous ethylene glycol solution at −10° C. was circulated. A 0.55 mass % solution of di-n-propyl peroxydicarbonate in methanol was prepared, and 18.6 mL of the solution was added to the flask, to initiate polymerization. Here, the amount of di-n-propyl peroxydicarbonate was 0.081 g. The solution of di-n-propyl peroxydicarbonate in methanol was successively added at a rate of 20.9 mL/hr until the polymerization was completed. During the polymerization, an internal temperature of the flask was kept at 60° C. Four hours after the initiation of the polymerization, that is, at the time when a solid concentration of the polymerization solution reached 25.1%, 1200 g of methanol containing 0.0141 g of sorbic acid (corresponding to 3 molar equivalents of the remaining undecomposed di-n-propyl peroxydicarbonate in the polymerization solution) was added, and then the polymerization solution was cooled to terminate the polymerization. At the end of the polymerization, a rate of polymerization of vinyl acetate was 35.0%. The polymerization solution was cooled to room temperature and then the inside of the flask was vacuumed using a tap aspirator to distill off vinyl acetate and methanol, resulting in precipitation of polyvinyl acetate. To the precipitated polyvinyl acetate was added 3000 g of methanol, and the mixture was heated at 30° C. to dissolve polyvinyl acetate. Again, the inside of the flask was vacuumed using a tap aspirator to distill off vinyl acetate and methanol, resulting in precipitation of polyvinyl acetate. The procedure of dissolving the polyvinyl acetate in methanol and precipitating it was repeated two more times. Methanol was added to the precipitated polyvinyl acetate to provide a 40 mass % of methanol solution of polyvinyl acetate (PVAc-1), having 99.8% of removal rate of vinyl acetate.

Using a part of the solution of PVAc-1 in methanol thus obtained, a degree of polymerization was measured. To the solution of PVAc-1 in methanol was added a 10% solution of sodium hydroxide in methanol in such an amount that a molar ratio of sodium hydroxide to a vinyl acetate monomer unit in the polyvinyl acetate was to be 0.1. At the time when a gelled substance was formed, the gel was crushed and soxhlet-extracted into methanol for 3 days. The polyvinyl alcohol thus obtained was dried and subjected to measurement of a viscosity-average degree of polymerization. The degree of polymerization was 1700.

### PVAc-2 to PVAc-20

Polyvinyl acetates (PVAc-2 to PVAc-20) were produced as described for PVAc-1, except the reaction was conducted under the conditions described in Table 1. In Table 1, “ND” means less than 1 ppm. A degree of polymerization of each polyvinyl acetate thus obtained was determined as described for PVAc-1. The results are shown in Table 1.

TABLE 1

| | | | Impurities | | Impurities | | Initiator¹⁾ | | | Polymeri- | Solid | Rate of | |
|---|---|---|---|---|---|---|---|---|---|---|---|---|---|
| | | | in VAM | | in MeOH | | Concen- | | | zation | concen- | polymeri- | Degree of |
| Synthetic | VAM | MeOH | AA | DMA | AA | DMA | tration | Initial | Successive | time | tration | zation | polymeri- |
| Examples | (g) | (g) | (ppm) | (ppm) | (ppm) | (ppm) | (g/L) | (mL) | (mL/hr) | (hr) | (%) | (%) | zation |
| PVAc-1 | 2555 | 945 | 500 | 50 | ND | 50 | 0.55 | 18.6 | 20.9 | 4.0 | 25.1 | 35.0 | 1700 |
| PVAc-2 | 1435 | 2065 | 600 | 60 | ND | 50 | 2.50 | 16.6 | 18.7 | 5.0 | 26.1 | 65.0 | 500 |
| PVAc-3 | 1055 | 2445 | 650 | 65 | ND | 50 | 3.00 | 15.6 | 17.5 | 6.0 | 22.1 | 75.0 | 300 |
| PVAc-4 | 2800 | 700 | 150 | 15 | ND | 50 | 0.30 | 10.2 | 11.5 | 4.0 | 15.8 | 20.0 | 2400 |
| PVAc-5 | 3164 | 336 | 100 | 10 | ND | 50 | 0.30 | 9.5 | 10.7 | 2.0 | 9.0 | 10.0 | 3600 |
| PVAc-6 | 2555 | 945 | 10 | 2 | ND | 5 | 0.20 | 51.1 | 57.4 | 4.0 | 24.3 | 35.0 | 1700 |
| PVAc-7 | 2590 | 910 | 950 | 50 | ND | 100 | 0.80 | 13.0 | 14.6 | 4.0 | 25.6 | 35.0 | 1700 |
| PVAc-8 | 2520 | 980 | ND | ND | ND | ND | 0.50 | 20.2 | 22.7 | 4.0 | 24.7 | 35.0 | 1700 |
| PVAc-9 | 2660 | 840 | 1500 | 100 | 150 | 20 | 0.80 | 13.3 | 14.9 | 4.0 | 26.3 | 35.0 | 1700 |
| PVAc-10 | 1050 | 2450 | ND | ND | ND | ND | 3.00 | 15.8 | 17.7 | 6.0 | 22.0 | 75.0 | 300 |
| PVAc-11 | 1085 | 2415 | 2000 | 180 | 200 | 25 | 3.00 | 16.3 | 18.3 | 6.0 | 22.7 | 75.0 | 300 |
| PVAc-12 | 1400 | 2100 | ND | ND | ND | ND | 2.50 | 16.2 | 18.3 | 5.0 | 25.5 | 65.0 | 500 |
| PVAc-13 | 1470 | 2030 | 1700 | 150 | 180 | 25 | 2.50 | 17.1 | 19.2 | 5.0 | 26.7 | 65.0 | 500 |
| PVAc-14 | 2800 | 700 | ND | ND | ND | ND | 0.10 | 20.5 | 23.0 | 4.0 | 15.7 | 20.0 | 2400 |
| PVAc-15 | 2958 | 542 | 1500 | 100 | 100 | 15 | 0.20 | 14.8 | 16.6 | 4.0 | 16.7 | 20.0 | 2400 |
| PVAc-16 | 3150 | 350 | ND | ND | ND | ND | 0.30 | 9.5 | 10.6 | 2.0 | 9.0 | 10.0 | 3600 |
| PVAc-17 | 3325 | 175 | 1300 | 120 | 100 | 15 | 0.30 | 8.0 | 9.0 | 2.0 | 8.5 | 9.0 | 3600 |
| PVAc-18 | 665 | 2835 | 650 | 65 | ND | 50 | 3.00 | 24.4 | 27.4 | 8.0 | 16.1 | 89.0 | 150 |
| PVAc-19²⁾ | 3378 | 122 | 100 | 10 | ND | 50 | 0.10 | 60.8 | 18.7 | 2.0 | 4.8 | 5.0 | 5500 |
| PVAc-20 | 2293 | 1207 | 10 | 2 | ND | 5 | 0.10 | 11.0 | 12.4 | 2.0 | 3.3 | 5.0 | 1700 |

¹⁾Initiator: solution of di-n-propyl peroxydicarbonate in MeOH
²⁾Polymerization temperature: 50° C.

### PVAc-A to H

Polyvinyl acetates PVAc-A to H were produced as described for PVAc-1, except the reaction was conducted under the conditions described in Table 2. A modified amount of each comonomer was determined from a sample dissolved in DMSO-d₆ or CDCl₃ using a proton NMR spectrometer (GX-500 from JEOL Ltd.) at 500 MHz.

TABLE 2

| | | | Impurities | | Impurities | | Initiator¹⁾ | | | |
|---|---|---|---|---|---|---|---|---|---|---|
| | | | in VAM | | in MeOH | | Concen- | | | Comonomer²⁾ |
| Synthetic | VAM | MeOH | AA | DMA | AA | DMA | tration | Initial | Successive | Type of |
| Examples | (g) | (g) | (ppm) | (ppm) | (ppm) | (ppm) | (g/L) | (mL) | (mL/hr) | comonomer |
| PVAc-A | 2625 | 875 | 500 | 50 | ND | 50 | 0.55 | 18.5 | 20.8 | N-vinylacetoamide |
| | | | | | | | | | | (NVA) |
| PVAc-B | 2625 | 875 | 500 | 50 | ND | 50 | 0.55 | 18.5 | 20.8 | N-vinylacetoamide |
| | | | | | | | | | | (NVA) |
| PVAc-C | 1400 | 2100 | 600 | 60 | ND | 50 | 2.5 | 16.2 | 18.3 | N-vinylacetoamide |
| | | | | | | | | | | (NVA) |
| PVAc-D | 2625 | 875 | 500 | 50 | ND | 50 | 0.55 | 18.5 | 20.8 | N-vinylcaprolactam |
| | | | | | | | | | | (NVC) |
| PVAc-E | 2625 | 875 | 500 | 50 | ND | 50 | 0.55 | 18.5 | 20.8 | N-vinylcaprolactam |
| | | | | | | | | | | (NVC) |
| PVAc-F | 1400 | 2100 | 600 | 60 | ND | 50 | 2.5 | 12.6 | 14.2 | N-vinylcaprolactam |
| | | | | | | | | | | (NVC) |
| PVAc-G | 2625 | 875 | 500 | 50 | ND | 50 | 0.55 | 18.5 | 20.8 | N-(methoxymeth- |
| | | | | | | | | | | yl)methacrylamide |
| | | | | | | | | | | (NMMM) |
| PVAc-H | 2590 | 910 | ND | ND | ND | ND | 0.50 | 20.2 | 22.7 | N-vinylacetoamide |
| | | | | | | | | | | (NVA) |

| | Comonomer²⁾ | | | | | | | |
|---|---|---|---|---|---|---|---|---|
| | | | Amount of | | Solid | Rate of | | |
| | Concen- | | successive | Polymeri- | concen- | polymeri- | Degree of | Modified |
| Synthetic | tration | Initial | addition | zation time | tration | zation | polymeri- | amount |
| Examples | (wt %) | (mL) | (mL) | (hr) | (%) | (%) | zation | [mol %] |
| PVAc-A | 10 | 42.6 | 101.0 | 4.0 | 26.5 | 35.0 | 1700 | 1 |
| PVAc-B | 5 | 41.3 | 101.0 | 4.0 | 25.3 | 35.0 | 1700 | 0.5 |
| PVAc-C | 10 | 22.8 | 100.0 | 5.0 | 25.2 | 65.0 | 500 | 1 |
| PVAc-D | 11 | 225.7 | 91.5 | 4.0 | 25.9 | 35.0 | 1700 | 1 |
| PVAc-E | 5 | 254.5 | 97.6 | 4.0 | 25.5 | 35.0 | 1700 | 0.5 |
| PVAc-F | 25 | 231.0 | 219.0 | 5.0 | 24.6 | 60.0 | 500 | 5 |
| PVAc-G | 20 | 21.4 | 79.5 | 4.0 | 25.7 | 35.0 | 1700 | 1 |
| PVAc-H | 10 | 42.0 | 99.6 | 4.0 | 25.2 | 35.0 | 1700 | 1 |

¹⁾Initiator: solution of di-n-propyl peroxydicarbonate in MeOH
²⁾MeOH solution of the comonomer

### [Synthesis of Polyvinyl Alcohol]

### PVA-1

To a 40 mass % solution of PVAc-1 in methanol were added methanol and a 8% solution of sodium hydroxide in methanol in such an amount that a total solid concentration (saponification concentration) was to be 30 mass % and also a molar ratio of sodium hydroxide to a vinyl acetate monomer unit in the polyvinyl acetate was to be 0.02 with stirring, and a saponification reaction was initiated at 40° C. At the time when a gelled substance was formed with progress of the saponification reaction, the gel was crushed. The crushed gel was transferred into a vessel at 40° C., and after the lapse of 60 min. from the initiation of the saponification reaction, was immersed in a solution of methanol/methyl acetate/water (25/70/5 by mass) for neutralization. The swollen gel thus obtained was collected by centrifugation and a two-fold amount of methanol to the mass of the swollen gel was added for immersion. After standing the mixture for 30 min., it was collected by centrifugation. This procedure was repeated four times. The product was dried at 60° C. for one hour and then at 100° C. for 2 hours to afford PVA-1.

A degree of polymerization and a degree of saponification of PVA-1 were determined in accordance with the method described in JIS-K6726. The degree of polymerization was 1700, and the degree of saponification was 99.1 mol %. The physical property data of them is also shown in Table 3.

After ashing PVA-1, the amount of sodium in the ash obtained was measured by an ICP emission spectrometer “IRIS AP” from Jarrell Ash Corporation to determine a content of sodium acetate in PVA-1. A content of sodium acetate was 0.7% (0.20% in terms of sodium). The physical property data of them is also shown in Table 3.

### PVA-2 to 23, Comparative PVA-1 to 21 and Comparative PVA-24 to 29

Each PVA was synthesized as described for PVA-1, except that the reaction was conducted under the conditions shown in Tables 3 and 4. A degree of polymerization, a degree of saponification, and a content of sodium acetate (converted to the mass of sodium) of the PVA thus obtained were determined as described for PVA-1. The results are shown in Tables 3 and 4.

### Comparative PVA-22

To a 55 mass % solution of polyvinyl acetate of PVAc-3 in methanol were added methanol and a 8% solution of sodium hydroxide in methanol in such an amount that a total solid concentration (saponification concentration) was to be 40 mass % and also a molar ratio of sodium hydroxide to a vinyl acetate monomer unit in the polyvinyl acetate was to be 0.005 with stirring, and a saponification reaction was initiated at 40° C. Here, distilled water was added in such an amount that a water content in the system was to be 3.0% for saponification reaction. One hour after the addition of the solution of sodium hydroxide in methanol, 0.8 molar equivalents of sodium hydroxide of 1% acetic acid water and a large amount of distilled water were added to terminate the saponification reaction. The obtained solution was transferred into a dryer and dried at 65° C. for 12 hours and then at 100° C. for 2 hours to afford Comparative PVA-22.

A degree of polymerization, a degree of saponification, and a content of sodium acetate of Comparative PVA-22 were determined as described for PVA-1. The degree of polymerization was 300, the degree of saponification was 45.3 mol %, and the content of sodium acetate was 1.2% (0.34% in terms of sodium). The results are shown in Table 4.

### Comparative PVA-23

To a 55 mass % solution of polyvinyl acetate of PVAc-3 in methanol were added methanol and a 8% solution of sodium hydroxide in methanol in such an amount that a total solid concentration (saponification concentration) was to be 40 mass % and also a molar ratio of sodium hydroxide to a vinyl acetate monomer unit in the polyvinyl acetate was to be 0.005 with stirring, and a saponification reaction was initiated at 40° C. Here, distilled water was added in such an amount that a water content in the system was to be 1.2% for saponification reaction. One hour after the addition of the solution of sodium hydroxide in methanol, 0.8 molar equivalents of sodium hydroxide of 1% acetic acid water and a large amount of distilled water were added to terminate the saponification reaction. The obtained solution was transferred into a dryer and dried at 65° C. for 12 hours and then at 100° C. for 2 hours to afford Comparative PVA-23.

A degree of polymerization, a degree of saponification, and a content of sodium acetate of Comparative PVA-23 were determined as described for PVA-1. The degree of polymerization was 300, the degree of saponification was 60.2 mol %, and the content of sodium acetate was 1.3% (0.36% in terms of sodium). The results are shown in Table 4.

TABLE 3

| | | Saponification | | | | | Degree of | |
|---|---|---|---|---|---|---|---|---|
| | | Saponification | NaOH | Washing ²⁾ | | Degree of | saponifi- | |
| Synthetic | | concentration | (molar | Amount | | polymeri- | cation | Na |
| Examples | PVAc¹⁾ | (%) | ratio) | of MeOH | Number | zation | (mol %) | (%) |
| PVA-1 | PVAc-1 | 30 | 0.02 | 2 | 4 | 1700 | 99.1 | 0.20 |
| PVA-2 | PVAc-6 | 30 | 0.02 | 2 | 4 | 1700 | 99.1 | 0.11 |
| PVA-3 | PVAc-7 | 30 | 0.02 | 1.5 | 3 | 1700 | 99.1 | 0.31 |
| PVA-4 | PVAc-3 (26.6) | 30 | 0.02 | 2 | 4 | 1700 | 99.2 | 0.17 |
| | PVAc-4 (73.4) | | | | | | | |
| PVA-5 | PVAc-2 (31.0) | 30 | 0.02 | 2 | 4 | 1700 | 99.2 | 0.17 |
| | PVAc-4 (69.0) | | | | | | | |
| PVA-6 | PVAc-18 (42.1) | 30 | 0.02 | 2 | 4 | 1700 | 99.2 | 0.22 |
| | PVAc-5 (57.9) | | | | | | | |
| PVA-7 | PVAc-20 | 30 | 0.02 | 2 | 4 | 1700 | 99.1 | 0.20 |
| PVA-8 | PVAc-1 | 30 | 0.02 | 1.4 | 3 | 1700 | 99.1 | 0.39 |
| PVA-9 | PVAc-3 | 55 | 0.03 | 2.5 | 4 | 300 | 98.9 | 0.11 |
| PVA-10 | PVAc-2 | 40 | 0.025 | 2 | 4 | 500 | 98.5 | 0.22 |
| PVA-11 | PVAc-4 | 25 | 0.018 | 2 | 4 | 2400 | 98.7 | 0.14 |
| PVA-12 | PVAc-5 | 15 | 0.015 | 2 | 4 | 3600 | 98.5 | 0.17 |
| Comparative | PVAc-8 | 30 | 0.02 | 2 | 4 | 1700 | 99.2 | 0.20 |
| PVA-1 | | | | | | | | |
| Comparative | PVAc-9 | 30 | 0.02 | 2 | 4 | 1700 | 99.1 | 0.17 |
| PVA-2 | | | | | | | | |
| Comparative | PVAc-10 (26.6) | 30 | 0.02 | 2 | 4 | 1700 | 99.1 | 0.20 |
| PVA-3 | PVAc-14 (73.4) | | | | | | | |
| Comparative | PVAc-11 (26.6) | 30 | 0.02 | 2 | 4 | 1700 | 99.2 | 0.20 |
| PVA-4 | PVAc-15 (73.4) | | | | | | | |
| Comparative | PVAc-1 | 30 | 0.02 | 1 | 2 | 1700 | 99.2 | 0.56 |
| PVA-5 | | | | | | | | |
| Comparative | PVAc-10 | 55 | 0.03 | 2.5 | 4 | 300 | 98.5 | 0.14 |
| PVA-6 | | | | | | | | |
| Comparative | PVAc-11 | 55 | 0.03 | 2.5 | 4 | 300 | 98.6 | 0.20 |
| PVA-7 | | | | | | | | |
| Comparative | PVAc-18 | 65 | 0.04 | 2.5 | 4 | 150 | 98.9 | 0.39 |
| PVA-8 | | | | | | | | |
| Comparative | PVAc-12 | 40 | 0.025 | 2 | 4 | 500 | 98.5 | 0.14 |
| PVA-9 | | | | | | | | |
| Comparative | PVAc-13 | 40 | 0.025 | 2 | 4 | 500 | 98.6 | 0.20 |
| PVA-10 | | | | | | | | |
| Comparative | PVAc-14 | 25 | 0.018 | 2 | 4 | 2400 | 98.3 | 0.11 |
| PVA-11 | | | | | | | | |
| Comparative | PVAc-15 | 25 | 0.018 | 2 | 4 | 2400 | 98.3 | 0.22 |
| PVA-12 | | | | | | | | |
| Comparative | PVAc-16 | 15 | 0.015 | 2 | 4 | 3600 | 98.3 | 0.11 |
| PVA-13 | | | | | | | | |
| Comparative | PVAc-17 | 15 | 0.015 | 2 | 4 | 3600 | 98.3 | 0.22 |
| PVA-14 | | | | | | | | |
| Comparative | PVAc-19 | 8 | 0.015 | 2 | 4 | 5500 | 99.2 | 0.22 |
| PVA-15 | | | | | | | | |

¹⁾A value in parentheses is a mixing mass ratio of PVAc.
²⁾ The amount of MeOH used for washing a swollen gel after neutralization (a mass ratio of MeOH to a swollen gel) and the number of washing

TABLE 4

| | | Saponification | | | | | Degree of | |
|---|---|---|---|---|---|---|---|---|
| | | Saponification | NaOH | Washing ²⁾ | | Degree of | Saponifi- | |
| Synthetic | | concentration | (molar | Amount | | polymeri- | cation | Na |
| Examples | PVAc¹⁾ | (%) | ratio) | of MeOH | Number | zation | (mol %) | (%) |
| PVA-13 | PVAc-1 | 30 | 0.008 | 2 | 3 | 1700 | 88.2 | 0.20 |
| PVA-14 | PVAc-6 | 30 | 0.008 | 2 | 3 | 1700 | 88.1 | 0.11 |
| PVA-15 | PVAc-7 | 30 | 0.008 | 2 | 3 | 1700 | 88.3 | 0.14 |
| PVA-16 | PVAc-3 (26.6) | 30 | 0.008 | 2 | 3 | 1700 | 87.9 | 0.17 |
| | PVAc-4 (73.4) | | | | | | | |
| PVA-17 | PVAc-2 (31.0) | 30 | 0.008 | 2 | 3 | 1700 | 88.4 | 0.17 |
| | PVAc-4 (69.0) | | | | | | | |
| PVA-18 | PVAc-18 (42.1) | 30 | 0.008 | 2 | 3 | 1700 | 88.3 | 0.20 |
| | PVAc-5 (57.9) | | | | | | | |
| PVA-19 | PVAc-20 | 30 | 0.008 | 2 | 3 | 1700 | 87.8 | 0.20 |
| PVA-20 | PVAc-3 | 55 | 0.011 | 2 | 3 | 300 | 88.1 | 0.11 |
| PVA-21 | PVAc-2 | 40 | 0.01 | 2 | 3 | 500 | 88.0 | 0.22 |
| PVA-22 | PVAc-4 | 25 | 0.007 | 2 | 3 | 2400 | 88.3 | 0.25 |
| PVA-23 | PVAc-5 | 15 | 0.006 | 2 | 3 | 3600 | 87.8 | 0.11 |
| Comparative | PVAc-8 | 30 | 0.008 | 2 | 3 | 1700 | 88.2 | 0.14 |
| PVA-16 | | | | | | | | |
| Comparative | PVAc-9 | 30 | 0.008 | 2 | 3 | 1700 | 88.1 | 0.14 |
| PVA-17 | | | | | | | | |
| Comparative | PVAc-10 (26.6) | 30 | 0.008 | 2 | 3 | 1700 | 88.0 | 0.11 |
| PVA-18 | PVAc-14 (73.4) | | | | | | | |
| Comparative | PVAc-11 (31.0) | 30 | 0.008 | 2 | 3 | 1700 | 88.3 | 0.14 |
| PVA-19 | PVAc-15 (69.0) | | | | | | | |
| Comparative | PVAc-10 | 55 | 0.011 | 2 | 3 | 300 | 88.0 | 0.25 |
| PVA-20 | | | | | | | | |
| Comparative | PVAc-11 | 55 | 0.011 | 2 | 3 | 300 | 88.2 | 0.22 |
| PVA-21 | | | | | | | | |
| Comparative | PVAc-3 | 40 | 0.005 | Not | 0 | 300 | 45.3 | 0.34 |
| PVA-22 | | | | contained | | | | |
| Comparative | PVAc-3 | 40 | 0.005 | Not | 0 | 300 | 60.2 | 0.36 |
| PVA-23 | | | | contained | | | | |
| Comparative | PVAc-12 | 40 | 0.01 | 2 | 3 | 500 | 88.1 | 0.25 |
| PVA-24 | | | | | | | | |
| Comparative | PVAc-13 | 40 | 0.01 | 2 | 3 | 500 | 88.1 | 0.22 |
| PVA-25 | | | | | | | | |
| Comparative | PVAc-14 | 25 | 0.007 | 2 | 3 | 2400 | 88.2 | 0.17 |
| PVA-26 | | | | | | | | |
| Comparative | PVAc-15 | 25 | 0.007 | 2 | 3 | 2400 | 88.3 | 0.17 |
| PVA-27 | | | | | | | | |
| Comparative | PVAc-16 | 15 | 0.006 | 2 | 3 | 3600 | 87.9 | 0.11 |
| PVA-28 | | | | | | | | |
| Comparative | PVAc-17 | 15 | 0.006 | 2 | 3 | 3600 | 88.0 | 0.22 |
| PVA-29 | | | | | | | | |

¹⁾A value in parentheses is a mixing mass ratio of PVAc.
²⁾ The amount of MeOH used for washing a swollen gel after neutralization (a mass ratio of MeOH to a swollen gel) and the number of washing

### PVA-A1 to G and Comparative PVA-H1 and H2

Each PVA was synthesized as described for PVA-1, except that the reaction was conducted under the conditions shown in Table 5. A degree of polymerization, a degree of saponification, and a content of sodium acetate (converted to the mass of sodium) of the PVA thus obtained were determined as described for PVA-1. The results are shown in Table 5.

### [Method of Analyzing PVA]

PVA was analyzed in accordance with, unless otherwise indicated, the method described in JIS-K6726. The contents of a N-vinylamide monomer unit and an acrylamide monomer unit contained in PVA were determined from a sample dissolved in DMSO-d₆ using a proton NMR spectrometer (GX-500 from JEOL Ltd.) at 500 MHz.

TABLE 5

| | | Saponification | | | | | Degree of | | | |
|---|---|---|---|---|---|---|---|---|---|---|
| | | Saponification | NaOH | Washing ²⁾ | | Degree of | saponifi- | | Type of | Modified |
| Synthetic | | concentration | (molar | Amount | | polymeri- | cation | Na | comonomer | amount |
| Examples | PVAc¹⁾ | (%) | ratio) | of MeOH | Number | zation | (mol %) | (%) | [mol %] | [mol %] |
| PVA-A1 | PVAc-A | 30 | 0.022 | 2 | 4 | 1700 | 98.4 | 0.22 | NVA | 1 |
| PVA-A2 | PVAc-A | 30 | 0.0085 | 2 | 3 | 1700 | 88 | 0.21 | NVA | 1 |
| PVA-B | PVAc-B | 30 | 0.022 | 2 | 4 | 1700 | 98.7 | 0.21 | NVA | 0.5 |
| PVA-C | PVAc-C | 40 | 0.026 | 2 | 4 | 500 | 98.2 | 0.23 | NVA | 1 |
| PVA-D | PVAc-D | 30 | 0.022 | 2 | 4 | 1700 | 98.3 | 0.21 | NVC | 1 |
| PVA-E | PVAc-E | 30 | 0.022 | 2 | 4 | 1700 | 98.6 | 0.21 | NVC | 0.5 |
| PVA-F | PVAc-F | 40 | 0.026 | 2 | 4 | 500 | 98.1 | 0.21 | NVC | 5 |
| PVA-G | PVAc-G | 30 | 0.022 | 2 | 4 | 1700 | 98.4 | 0.22 | NMMM | 1 |
| Comparative | PVAc-H | 30 | 0.022 | 2 | 4 | 1700 | 98.5 | 0.21 | NVA | 1 |
| PVA-H1 | | | | | | | | | | |
| Comparative | PVAc-H | 30 | 0.0085 | 2 | 3 | 1700 | 88.2 | 0.20 | NVA | 1 |
| PVA-H2 | | | | | | | | | | |

¹⁾A value in parentheses is a mixing mass ratio of PVAc.
²⁾ The amount of MeOH used for washing a swollen gel after neutralization (a mass ratio of MeOH to a swollen gel) and the number of washing

### Example 1

In a 10 liter glass vessel equipped with a reflux condenser, a thermometer, and an anchor type impeller were charged 8100 g of ion-exchanged water and 660 g of PVA-1 (PVA concentration: 7.5%), and the contents were heated to 95° C. to completely dissolve the PVA. Then, the contents were gradually cooled to 10° C. over about 30 min. with stirring at 120 rpm. Then, to the vessel were added 384 g of n-butyraldehyde and 540 mL of 20% hydrochloric acid, to carry out a butyralation reaction for 150 min. Then, the mixture was heated to 60° C. over 60 min., kept at 60° C. for 120 min., and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral (PVB-1).

### (Composition of Polyvinyl Butyral)

With regard to polyvinyl butyral, a degree of butyralation (degree of acetalization), a content of a vinyl acetate monomer unit, and a content of a vinyl alcohol monomer unit were determined in accordance with JIS K6728. In polyvinyl butyral thus obtained, the degree of butyralation (degree of acetalization) was 68.2 mol %, a content of a vinyl acetate monomer unit was 0.9 mol %, and a content of a vinyl alcohol monomer unit was 30.9 mol %. The results are also shown in Table 6.

### [Method of Analyzing Vinyl Acetal-Based Polymer]

With regard to polyvinyl butyral, a degree of butyralation (degree of acetalization), a content of a vinyl acetate monomer unit, and a content of a vinyl alcohol monomer unit of polyvinyl butyral were determined in accordance with JIS K6728. The modified amount of aminoacetal in the vinyl acetal-based polymer was determined from a sample dissolved in DMSO-d₆ using a proton NMR spectrometer (GX-500 from JEOL Ltd.) at 500 MHz.

### [GPC Measurement of PVB]

### (Measuring Apparatus)

GPC measurement was conducted using “GPC max” from VISCOTECH Co. Ltd. A differential refractive index detector was “TDA305” from VISCOTECH Co. Ltd. An ultraviolet-visible absorptiometer was “UV Detector 2600” from VISCOTECH Co. Ltd. An optical path length of a detection cell in the absorptiometer was 10 mm. A GPC column was “GPC HFIP-806M” from Showa Denko K. K. The analysis software was OmniSEC (Version 4.7.0.406) attached to the apparatus.

### (Measurement Conditions)

A mobile phase was HFIP with 20 mmol/L sodium trifluoroacetate. A flow rate of the mobile phase was 1.0 mL/min. In the measurement, a sample injection volume was 100 μL and a GPC column temperature was 40° C.

For a sample with a viscosity-average degree of polymerization of more than 2400, GPC measurement was conducted using an appropriately diluted sample (100 μL). From an observed value, an absorbance at a sample concentration of 1.00 mg/mL was calculated by the following formula. The symbol “α” (mg/mL) is a concentration of the diluted sample.

Absorbance at a sample concentration of 1.00 mg/mL=(1.00/α)×a measured absorbance

### (Preparation of a Calibration Curve)

Measurement was conducted for polymethyl methacrylate (hereinafter, abbreviated as “PMMA”) (peak-top molecular weight: 1944000, 790000, 467400, 271400, 144000, 79250, 35300, 13300, 7100, 1960, 1020, 690) from Agilent Technologies as standards to prepare calibration curves for converting an elution volume to a PMMA molecular weight for a differential refractive index detector and an absorptiometer, respectively. For preparing each calibration curve, the above analysis software was used. In measurement of PMMA in this measurement, a column capable of separating the peaks of standard samples with a molecular weight of 1944000 and 271400, respectively, was used.

In this apparatus, peak intensity obtained from a differential refractive index detector is expressed in mV (millivolt unit), and peak intensity obtained from an absorptiometer is expressed in an absorbance (abs unit: absorbance unit).

### (Sample Preparation)

The PVB-1 in powder obtained was heated by hot pressing at a pressure of 2 MPa and 230° C. for 3 hours to provide heated polyvinyl acetal (film). The film thickness at this point was 760 μm. This film was subjected to GPC measurement.

The sample prepared by the method described above was dissolved in hexafluoroisopropanol (hereinafter, abbreviated as “HFIP”) with 20 mmol/L sodium trifluoroacetate to prepare a 1.00 mg/mL PVB solution. The solution was filtrated through a 0.45 μm polytetrafluoroethylene filter and then subjected to measurement.

The sample thus obtained was subjected to GPC measurement by the above method. FIG. 1 is a graph illustrating relationship between a molecular weight and a value as measured by a differential refractive index detector and relationship between a molecular weight and an absorbance as measured by an absorptiometer (measurement wavelength: 280 nm). The molecular weight at this point was converted from an elution volume using the calibration curve (PMMA-converted molecular weight). A peak-top molecular weight (A) measured by a differential refractive index detector was 90000, and a peak-top molecular weight (B) measured by an absorptiometer (280 nm) was 68900, which were determined from FIG. 1.

The values thus obtained were substituted into the following formula:

(A−B)/A,

to give a value of 0.23. The absorbance (b) in the peak-top molecular weight (B) was 2.21×10⁻³. A ratio Mw/Mn of a weight-average molecular weight Mw to a number-average molecular weight Mn determined from the chromatogram (RI) in FIG. 1 was 3.4. The results are also shown in Table 6.

### [Production of Ceramic Slurry]

To a mixed solvent of 30 parts by mass of toluene and 30 parts by mass of ethanol, 15 parts by mass of polyvinyl butyral thus obtained was added and then stirred to dissolve polyvinyl butyral. To the solution, 3 parts by mass of dioctyl phthalate was added as a plasticizer and then stirred to dissolve the plasticizer. To the resin solution thus obtained, 100 parts by mass of barium titanate (“BT-02” manufactured by Sakai Chemical Industry Co., Ltd., average particle size of 0.2 μm) was added as ceramic powder and mixed in a ball mill for 24 hours to provide a ceramic slurry.

### [Production of Conductive Paste]

In a 2 liter separable flask equipped with a stirrer, a condenser, a thermometer, a hot water bath, and a nitrogen gas inlet, charged were PVB-1 obtained and dihydroterpinyl acetate as an organic solvent and stirred at a temperature of 80° C. for 4 hours to provide a polyvinyl acetal resin solution. The polyvinyl acetal resin solution thus obtained and nickel powder (“NFP 201” produced by JFE Mineral Co., Ltd.) were mixed and passed through a three roll mill several times to provide a conductive paste. Here, the composition ratio in the conductive paste was adjusted in such an amount that PVB-1 was to be 3 mass %, dihydroterpinyl acetate was to be 42 mass %, and nickel powder was to be 55 mass %.

### [Evaluation of Binder for Ceramic Formation]

### (Storage Stability of Ceramic Slurry)

The storage stability of the ceramic slurry thus obtained was evaluated according to a ratio of viscosity η₀ of the ceramic slurry immediately after production to viscosity η₁ one month after the production. The evaluation criteria were as follows.

Evaluation of A: 0.95<η₁/η₀<1.05

Evaluation of B: 0.85<η₁/η₀≦0.95 or 1.05≦η₁/η₀<1.15

Evaluation of C: η₁/η₀<0.85 or 1.15≦η₁/η₀

The viscosity of the ceramic slurry was measured using a rotary rheometer (ARES G2 from TA Instrument) in the following measurement conditions.

### <Measurement Conditions>

### Flow Sweep Mode

Shear rate: 100 (1/sec)

### Diameter of Rotary Disk: 40 mm

### Rotary Disk (Upper Part): Flat Plate

### Cone Angle of Rotary Disk (Lower Part): 0.02 Rad

### Truncation gap: 0.0262 mm

### (Amount of Carbon Residue in Ceramic Green Sheet)

The ceramic slurry thus obtained was coated on a polyester film subjected to release treatment in such an amount that a thickness after drying was to be approximately 10 μm and air dried at ordinary temperature for 1 hour, and then dried at a temperature of 80° C. for 3 hours and subsequently at a temperature of 120° C. for 2 hours using a hot air dryer to provide a ceramic green sheet.

For evaluation of an amount of carbon residue in the ceramic green sheet, Q5000IR from TA Instruments was used. The ceramic green sheet was heated in a platinum pan and a ratio of a residue in the resin portion was measured for evaluation. The evaluation criteria were as follows.

### Evaluation A: Residue in Resin Portion≦0.02 wt %

### Evaluation B: 0.02 wt %<Residue in Resin Portion≦0.05 wt %

### Evaluation C: 0.05 wt %<Residue in Resin Portion≦0.10 wt %

### <Measurement Conditions>

### Rate of Temperature Rise: 10° C./min.

### Atmosphere: In Air

### Temperature of Measurement Initiation: 30° C.

### Temperature of Measurement Termination: 1000° C.

### [Evaluation of Binder for Conductive Paste]

### (Storage Stability of Conductive Paste)

The storage stability of the conductive paste thus obtained was evaluated according to a ratio of viscosity η₀ of the conductive paste immediately after production to viscosity η₁ one month after the production. The evaluation criteria were as follows.

Evaluation of A: 0.95<η₁/η₀<1.05

Evaluation of B: 0.85<η₁/η₀≦0.95 or 1.05≦η₁/η₀<1.15

Evaluation of C: η₁/η₀<0.85 or 1.15≦η₁/η₀

The viscosity of the conductive paste was measured using a rotary rheometer (ARES G2 from TA Instrument) in the following measurement conditions.

### <Measurement Conditions>

### Flow Sweep Mode

Shear rate: 100 (1/sec)

### Diameter of Rotary Disk: 40 mm

### Rotary Disk (Upper Part): Flat Plate

### Cone Angle of Rotary Disk (Lower Part): 0.02 Rad

### Truncation gap: 0.0262 mm

### (Carbon Residue in Conductive Paste)

The carbon residue in the conductive paste was evaluated using Q5000IR from TA Instruments by heating in a platinum pan to measure a ratio of a residue in the resin portion. The evaluation criteria were as follows.

### Evaluation A: Residue in Resin Portion≦0.02 wt %

### Evaluation B: 0.02 wt %<Residue in Resin Portion≦0.05 wt %

### Evaluation C: 0.05 wt %<Residue in Resin Portion≦0.10 wt %

### <Measurement Conditions>

### Rate of Temperature Rise: 10° C./min.

### Atmosphere: In Air

### Temperature of Measurement Initiation: 30° C.

### Temperature of Measurement Termination: 1000° C.

### Examples 2 to 8

Polyvinyl butyral was synthesized as described for Example 1, except that the starting PVA was changed as shown in Table 6. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Example 9

Polyvinyl butyral was synthesized as described for Example 1, except that the amount of n-butyraldehyde was changed to 320 g. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Example 10

Polyvinyl butyral was synthesized as described for Example 1, except that the amount of n-butyraldehyde was changed to 362 g. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Example 11

Polyvinyl butyral was synthesized as described for Example 1, except that the amount of n-butyraldehyde was changed to 449 g. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Comparative Example 1

Polyvinyl butyral was synthesized as described for Example 1, except that the amount of n-butyraldehyde was changed to 271 g. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Comparative Example 2

In a 10 liter glass vessel equipped with a reflux condenser, a thermometer, and an anchor type impeller were charged 8100 g of ion-exchanged water and 660 g of PVA-1 (PVA concentration: 7.5%), and the contents were heated to 95° C. to completely dissolve the PVA. Then, the contents were gradually cooled to 10° C. over about 30 min. with stirring at 120 rpm. Then, to the vessel were added 740 g of n-butyraldehyde and 810 mL of 20% hydrochloric acid, to carry out a butyralation reaction for 150 min. Then, the mixture was heated to 80° C. over 90 min., kept at 80° C. for 16 hours, and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Comparative Examples 3 to 7

Polyvinyl butyral was synthesized as described for Example 1, except that the starting PVA was changed as shown in Table 6. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Comparative Example 8

Polyvinyl butyral was synthesized as described for Comparative Example 1, except that the starting PVA was changed to Comparative PVA-1. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Comparative Example 9

Polyvinyl butyral was synthesized as described for Example 9, except that the starting PVA was changed to Comparative PVA-1. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Comparative Example 10

Polyvinyl butyral was synthesized as described for Example 11, except that the starting PVA was changed to Comparative PVA-1. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Comparative Example 11

Polyvinyl butyral was synthesized as described for Comparative Example 8, except that the starting PVA was changed to Comparative PVA-2. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Comparative Example 12

Polyvinyl butyral was synthesized as described for Example 9, except that the starting PVA was changed to Comparative PVA-2. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

### Comparative Example 13

Polyvinyl butyral was synthesized as described for Example 11, except that the starting PVA was changed to Comparative PVA-2. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 6.

TABLE 6

| | | | | | | | | | Evaluation | | | |
|---|---|---|---|---|---|---|---|---|---|---|---|---|
| | | | Degree | Vinyl | Vinyl | | | | Storage | Amount of | Storage | Amount of |
| | | Degree | of | acetate | alcohol | | | | stability | carbon | stability | carbon |
| | | of | acetali- | monomer | monomer | | | | of | residue | of | residue in |
| | Starting | polymeri- | zation | unit | unit | (A − | Absorbance | Mw/ | ceramic | in green | conductive | conductive |
| Examples | PVA | zation | (mol %) | (mol %) | (mol %) | B)/A | (280 nm) | Mn | slurry | sheet | paste | paste |
| Example 1 | PVA-1 | 1700 | 68.2 | 0.9 | 30.9 | 0.23 | 2.21 × 10⁻³ | 3.4 | A | A | A | A |
| Example 2 | PVA-2 | 1700 | 68.2 | 0.9 | 30.9 | 0.52 | 1.17 × 10⁻³ | 3.1 | B | A | B | A |
| Example 3 | PVA-3 | 1700 | 68.4 | 0.9 | 30.7 | 0.14 | 4.70 × 10⁻³ | 3.3 | A | B | A | B |
| Example 4 | PVA-4 | 1700 | 68.3 | 0.8 | 30.9 | 0.57 | 1.81 × 10⁻³ | 8.3 | B | B | B | B |
| Example 5 | PVA-5 | 1700 | 68.1 | 0.8 | 31.1 | 0.53 | 2.04 × 10⁻³ | 5.6 | A | B | B | B |
| Example 6 | PVA-6 | 1700 | 69.3 | 0.8 | 29.9 | 0.59 | 3.09 × 10⁻³ | 8.1 | B | B | B | B |
| Example 7 | PVA-7 | 1700 | 68.6 | 0.9 | 30.5 | 0.11 | 0.67 × 10⁻³ | 2.7 | B | A | B | A |
| Example 8 | PVA-8 | 1700 | 68.5 | 0.9 | 30.6 | 0.16 | 4.79 × 10⁻³ | 3.3 | A | B | A | B |
| Example 9 | PVA-1 | 1700 | 56.8 | 0.9 | 42.3 | 0.20 | 2.32 × 10⁻³ | 3.1 | B | A | B | A |
| Example 10 | PVA-1 | 1700 | 64.3 | 0.9 | 34.8 | 0.21 | 2.27 × 10⁻³ | 3.3 | B | A | B | A |
| Example 11 | PVA-1 | 1700 | 79.8 | 0.9 | 19.3 | 0.25 | 2.18 × 10⁻³ | 3.5 | A | B | B | B |
| Comparative | PVA-1 | 1700 | 48.2 | 0.9 | 50.9 | 0.17 | 2.39 × 10⁻³ | 2.9 | C | B | C | B |
| Example 1 | | | | | | | | | | | | |
| Comparative | PVA-1 | 1700 | 87.4 | 0.9 | 11.7 | 0.27 | 2.14 × 10⁻³ | 3.6 | B | C | B | C |
| Example 2 | | | | | | | | | | | | |
| Comparative | Comparative | 1700 | 68.2 | 0.8 | 31.0 | 0.57 | 0.36 × 10⁻³ | 2.9 | C | A | C | A |
| Example 3 | PVA-1 | | | | | | | | | | | |
| Comparative | Comparative | 1700 | 68.4 | 0.9 | 30.7 | 0.09 | 10.88 × 10⁻³ | 3.7 | A | C | A | C |
| Example 4 | PVA-2 | | | | | | | | | | | |
| Comparative | Comparative | 1700 | 68.7 | 1.9 | 29.4 | 0.64 | 0.37 × 10⁻³ | 6.8 | C | A | C | A |
| Example 5 | PVA-3 | | | | | | | | | | | |
| Comparative | Comparative | 1700 | 68.9 | 0.8 | 30.3 | 0.24 | 10.49 × 10⁻³ | 7.4 | B | C | B | C |
| Example 6 | PVA-4 | | | | | | | | | | | |
| Comparative | Comparative | 1700 | 68.3 | 0.8 | 30.9 | 0.12 | 10.66 × 10⁻³ | 3.5 | A | C | A | C |
| Example 7 | PVA-5 | | | | | | | | | | | |
| Comparative | Comparative | 1700 | 48.5 | 0.8 | 50.7 | 0.53 | 0.41 × 10⁻³ | 2.5 | C | A | C | A |
| Example 8 | PVA-1 | | | | | | | | | | | |
| Comparative | Comparative | 1700 | 56.8 | 0.8 | 42.4 | 0.54 | 0.39 × 10⁻³ | 2.7 | C | A | C | A |
| Example 9 | PVA-1 | | | | | | | | | | | |
| Comparative | Comparative | 1700 | 79.8 | 0.8 | 19.4 | 0.58 | 0.34 × 10⁻³ | 3.2 | C | A | C | A |
| Example 10 | PVA-1 | | | | | | | | | | | |
| Comparative | Comparative | 1700 | 48.3 | 0.8 | 50.9 | 0.07 | 10.98 × 10⁻³ | 3.2 | B | C | B | C |
| Example 11 | PVA-2 | | | | | | | | | | | |
| Comparative | Comparative | 1700 | 56.6 | 0.8 | 42.6 | 0.08 | 10.93 × 10⁻³ | 3.5 | B | C | B | C |
| Example 12 | PVA-2 | | | | | | | | | | | |
| Comparative | Comparative | 1700 | 79.6 | 0.8 | 19.6 | 0.11 | 10.77 × 10⁻³ | 3.9 | A | C | A | C |
| Example 13 | PVA-2 | | | | | | | | | | | |

When a binder for ceramic formation of the present invention was used (Examples 1 to 11), the stability of the ceramic slurry was improved. In addition, when a binder for ceramic formation of the present invention was used, the amount of carbon residue in the ceramic green sheet was less. In contrast, when a binder for ceramic formation not satisfying the conditions defined in the present invention was used (Comparative Examples 1 to 13), any of the performances was reduced.

When a binder for a conductive paste of the present invention was used (Examples 1 to 11), the storage stability of the conductive paste was improved. In addition, when a binder for a conductive paste of the present invention was used, the amount of carbon residue was less. In contrast, when a binder for a conductive paste not satisfying the conditions defined in the present invention was used (Comparative Examples 1 to 13), any of the performances was reduced.

### Example 12

In a 10 liter glass vessel equipped with a reflux condenser, a thermometer, and an anchor type impeller were charged 8100 g of ion-exchanged water and 660 g of PVA-9 (PVA concentration: 7.5%), and the contents were heated to 95° C. to completely dissolve the PVA. Then, the contents were gradually cooled to 1° C. over about 30 min. with stirring at 120 rpm. Then, to the vessel were added 422 g of n-butyraldehyde and 540 mL of 20% hydrochloric acid, to carry out a butyralation reaction for 120 min. Then, the mixture was heated to 45° C. over 60 min., kept at 45° C. for 120 min., and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral.

The composition of polyvinyl butyral thus obtained was measured as described for Example 1. The degree of butyralation (degree of acetalization) was 68.1 mol %, the content of a vinyl acetate monomer unit was 1.1 mol %, and the content of a vinyl alcohol monomer unit was 30.8 mol %. Then, the evaluation (GPC measurement) of polyvinyl acetal thus obtained and the storage stability and the amount of carbon residue in the conductive paste were evaluated as described for Example 1. The results are shown in Table 7.

### Example 13

In a 10 liter glass vessel equipped with a reflux condenser, a thermometer, and an anchor type impeller were charged 8100 g of ion-exchanged water and 660 g of PVA-10 (PVA concentration: 7.5%), and the contents were heated to 95° C. to completely dissolve the PVA. Then, the contents were gradually cooled to 5° C. over about 30 min. with stirring at 120 rpm. Then, added were 402 g of n-butyraldehyde and 540 mL of 20% hydrochloric acid, to carry out a butyralation reaction for 120 min. Then, the mixture was heated to 50° C. over 60 min., kept at 50° C. for 120 min., and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral.

The composition of polyvinyl butyral thus obtained was measured as described for Example 1. The degree of butyralation (degree of acetalization) of polyvinyl butyral thus obtained was 68.5 mol %, the content of a vinyl acetate monomer unit was 1.5 mol %, and the content of a vinyl alcohol monomer unit was 30.0 mol %. Then, the evaluation (GPC measurement) of polyvinyl acetal thus obtained and the storage stability and the amount of carbon residue in the conductive paste were evaluated as described for Example 1. The results are shown in Table 7.

### Comparative Examples 14 to 16

Polyvinyl butyral was synthesized as described for Example 12, except that the starting PVA was changed as shown in Table 7. Then, the storage stability and the amount of carbon residue in the conductive paste were evaluated as described for Example 1. The results are shown in Table 7.

### Comparative Examples 17 and 18

Polyvinyl butyral was synthesized as described for Example 13, except that the starting PVA was changed as shown in Table 7. Then, the storage stability and the amount of carbon residue in the conductive paste were evaluated as described for Example 1. The results are shown in Table 7.

TABLE 7

| | | | | Vinyl | Vinyl | | | | | |
|---|---|---|---|---|---|---|---|---|---|---|
| | | | Degree of | acetate | alcohol | | | | Evaluation | |
| | | Degree of | acetaliza- | monomer | monomer | | | | Storage | Amount of carbon |
| | Starting | polymeri- | tion | unit | unit | (A − | Absorbance | | stability of | residue in |
| Examples | PVA | zation | (mol %) | (mol %) | (mol %) | B)/A | (280 nm) | Mw/Mn | conductive paste | conductive paste |
| Example 12 | PVA-9 | 300 | 68.1 | 1.1 | 30.8 | 0.10 | 3.44 × 10⁻³ | 3.4 | A | B |
| Example 13 | PVA-10 | 500 | 68.5 | 1.5 | 30.0 | 0.20 | 2.59 × 10⁻³ | 3.6 | A | A |
| Comparative | Comparative | 300 | 68.1 | 1.5 | 30.4 | 0.45 | 0.41 × 10⁻³ | 3.3 | C | A |
| Example 14 | PVA-6 | | | | | | | | | |
| Comparative | Comparative | 300 | 68.2 | 1.4 | 30.4 | 0.06 | 11.21 × 10⁻³ | 3.7 | B | C |
| Example 15 | PVA-7 | | | | | | | | | |
| Comparative | Comparative | 150 | 68.1 | 1.1 | 30.8 | 0.51 | 4.70 × 10⁻³ | 3.3 | C | C |
| Example 16 | PVA-8 | | | | | | | | | |
| Comparative | Comparative | 500 | 68.4 | 1.5 | 30.1 | 0.46 | 0.39 × 10⁻³ | 3.2 | C | A |
| Example 17 | PVA-9 | | | | | | | | | |
| Comparative | Comparative | 500 | 68.6 | 1.4 | 30.0 | 0.08 | 10.98 × 10⁻³ | 3.7 | A | C |
| Example 18 | PVA-10 | | | | | | | | | |

When a binder for a conductive paste of the present invention was used (Examples 12 and 13), the storage stability of the conductive paste was improved. In addition, when a binder for a conductive paste of the present invention was used, the amount of carbon residue was less. In contrast, when a binder for a conductive paste not satisfying the conditions defined in the present invention was used (Comparative Examples 14, 15, 17 and 18), any of the performances was reduced. When the degree of polymerization was less than the lower limit defined in the present invention (Comparative Example 16), all performances were insufficient.

### Example 14

In a 10 liter glass vessel equipped with a reflux condenser, a thermometer, and an anchor type impeller were charged 8234 g of ion-water and 526 g of PVA-11 (PVA concentration: 6.0%), and the contents were heated to 95° C. to completely dissolve the PVA. Then, the contents were gradually cooled to 15° C. over about 30 min. with stirring at 120 rpm. Then, to the vessel were added 307 g of n-butyraldehyde and 540 mL of 20% hydrochloric acid, to carry out a butyralation reaction for 120 min. Then, the mixture was heated to 60° C. over 60 min., kept at 60° C. for 120 min., and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral. The degree of butyralation (degree of acetalization) of polyvinyl butyral thus obtained was 68.2 mol %, the content of a vinyl acetate monomer unit was 1.3 mol %, and the content of a vinyl alcohol monomer unit was 30.5 mol %.

The composition of polyvinyl butyral thus obtained was measured as described for Example 1. The degree of butyralation (degree of acetalization) was 68.2 mol %, the content of a vinyl acetate monomer unit was 1.3 mol %, and the content of a vinyl alcohol monomer unit was 30.5 mol %. Then, the evaluation (GPC measurement) of polyvinyl acetal thus obtained, the storage stability of the ceramic slurry, the amount of carbon residue in the ceramic green sheet, the storage stability of the conductive paste, and the amount of carbon residue in the conductive paste were evaluated as described for Example 1. The results are shown in Table 8.

### Example 15

In a 10 liter glass vessel equipped with a reflux condenser, a thermometer, and an anchor type impeller were charged 8322 of ion-exchanged water and 438 g of PVA-12 (PVA concentration: 5.0%), and the contents were heated to 95° C. to completely dissolve the PVA. Then, the contents were gradually cooled to 20° C. over about 30 min. with stirring at 120 rpm. Then, to the vessel were added 256 g of n-butyraldehyde and 540 mL of 20% hydrochloric acid, to carry out a butyralation reaction for 120 min. Then, the mixture was heated to 60° C. over 60 min., kept at 60° C. for 120 min., and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral.

The composition of polyvinyl butyral thus obtained was measured as described for Example 1. The degree of butyralation (degree of acetalization) was 68.1 mol %, the content of a vinyl acetate monomer unit was 1.5 mol %, and the content of a vinyl alcohol monomer unit was 30.4 mol %. Then, the evaluation (GPC measurement) of polyvinyl acetal thus obtained, the storage stability of the ceramic slurry, the amount of carbon residue in the ceramic green sheet, the storage stability of the conductive paste, and the amount of carbon residue in the conductive paste were evaluated as described for Example 1. The results are shown in Table 8.

### Comparative Examples 19 and 20

Polyvinyl butyral was synthesized as described for Example 14, except that the starting PVA was changed as shown in Table 8. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 8.

### Comparative Examples 21 to 23

Polyvinyl butyral was synthesized as described for Example 15, except that the starting PVA was changed as shown in Table 8. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 8.

When a binder for ceramic formation of the present invention was used (Examples 14 and 15), the stability of the ceramic slurry was improved. In addition, when a binder for ceramic formation of the present invention was used, the amount of carbon residue in the ceramic green sheet was less. In contrast, when a binder for ceramic formation not satisfying the conditions defined in the present invention was used (Comparative Examples 19 to 22), any of the performances was reduced. In addition, when a binder for ceramic formation made from polyvinyl acetal having a degree of polymerization of more than 5000 was used (Comparative Example 23), all performances were insufficient.

TABLE 8

| | | | | | | | | | Evaluation | | | |
|---|---|---|---|---|---|---|---|---|---|---|---|---|
| | | | Degree | Vinyl | Vinyl | | | | Storage | Amount of | Storage | Amount of |
| | | Degree | of | acetate | alcohol | | | | stability | carbon | stability | carbon |
| | | of | acetali- | monomer | monomer | | | | of | residue | of | residue in |
| | Starting | polymeri- | zation | unit | unit | (A − | Absorbance | Mw/ | ceramic | in green | conductive | conductive |
| Examples | PVA | zation | (mol %) | (mol %) | (mol %) | B)/A | (280 nm) | Mn | slurry | sheet | paste | paste |
| Example 14 | PVA-11 | 2400 | 68.2 | 1.3 | 30.5 | 0.51 | 1.98 × 10⁻³ | 3.4 | A | A | A | A |
| Example 15 | PVA-12 | 3600 | 68.1 | 1.5 | 30.4 | 0.53 | 1.73 × 10⁻³ | 3.2 | B | B | B | B |
| Comparative | Comparative | 2400 | 68.2 | 1.7 | 30.1 | 0.62 | 0.32 × 10⁻³ | 3.1 | C | A | C | A |
| Example 19 | PVA-11 | | | | | | | | | | | |
| Comparative | Comparative | 2400 | 68.3 | 1.7 | 30.0 | 0.14 | 10.27 × 10⁻³ | 3.8 | A | C | A | C |
| Example 20 | PVA-12 | | | | | | | | | | | |
| Comparative | Comparative | 3600 | 68.3 | 1.7 | 30.0 | 0.64 | 0.31 × 10⁻³ | 2.9 | C | A | C | A |
| Example 21 | PVA-13 | | | | | | | | | | | |
| Comparative | Comparative | 3600 | 68.4 | 1.7 | 29.9 | 0.17 | 10.11 × 10⁻³ | 4.0 | B | C | B | C |
| Example 22 | PVA-14 | | | | | | | | | | | |
| Comparative | Comparative | 5500 | 68.8 | 0.8 | 30.4 | 0.55 | 1.67 × 10⁻³ | 3.1 | C | C | C | C |
| Example 23 | PVA-15 | | | | | | | | | | | |

### Example 16

In a 10 liter glass vessel equipped with a reflux condenser, a thermometer, and an anchor type impeller were charged 8100 of ion-exchanged water and 660 g of PVA-13 (PVA concentration: 7.5%), and the contents were heated to 95° C. to completely dissolve the PVA. Then, the contents were gradually cooled to 15° C. over about 30 min. with stirring at 120 rpm. Then, to the vessel were added 432 g of n-butyraldehyde and 540 mL of 20% hydrochloric acid, to carry out a butyralation reaction for 90 min. Then, the mixture was heated to 45° C. over 30 min., kept at 45° C. for 180 min., and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral.

The composition of polyvinyl butyral thus obtained was measured as described for Example 1. The degree of butyralation (degree of acetalization) was 74.1 mol %, the content of a vinyl acetate monomer unit was 8.1 mol %, and the content of a vinyl alcohol monomer unit was 17.8 mol %. Then, the evaluation (GPC measurement) of polyvinyl acetal thus obtained, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Examples 17 to 22

Polyvinyl butyral was synthesized as described for Example 16, except that the starting PVA was changed as shown in Table 9. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Example 23

Polyvinyl butyral was synthesized as described for Example 16, except that the amount of n-butyraldehyde was changed to 269 g. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Example 24

Polyvinyl butyral was synthesized as described for Example 16, except that the amount of n-butyraldehyde was changed to 307 g. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Example 25

Polyvinyl butyral was synthesized as described for Example 16, except that the amount of n-butyraldehyde was changed to 458 g. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Comparative Example 24

Polyvinyl butyral was synthesized as described for Example 16, except that the amount of n-butyraldehyde was changed to 225 g. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Comparative Example 25

In a 10 liter glass vessel equipped with a reflux condenser, a thermometer, and an anchor type impeller were charged 8100 of ion-exchanged water and 660 g of PVA-13 (PVA concentration: 7.5%), and the contents were heated to 95° C. to completely dissolve the PVA. Then, the contents were gradually cooled to 15° C. over about 30 min. with stirring at 120 rpm. Then, to the vessel were added 837 g of n-butyraldehyde and 810 mL of 20% hydrochloric acid, to carry out a butyralation reaction for 90 min. Then, the mixture was heated to 60° C. over 60 min., kept at 60° C. for 24 hours, and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral. Then, the storage stability of the ceramic slurry, the amount of carbon residue in the ceramic green sheet, the storage stability of the conductive paste, and the amount of carbon residue in the conductive paste were evaluated as described for Example 16. The results are shown in Table 9.

### Comparative Examples 26 to 29

Polyvinyl butyral was synthesized as described for Example 16, except that the starting PVA was changed as shown in Table 9. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Comparative Example 30

Polyvinyl butyral was synthesized as described for Comparative Example 24, except that the starting PVA was changed to Comparative PVA-16. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Comparative Example 31

Polyvinyl butyral was synthesized as described for Example 23, except that the starting PVA was changed to Comparative PVA-16. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Comparative Example 32

Polyvinyl butyral was synthesized as described for Example 25, except that the starting PVA was changed to Comparative PVA-16. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Comparative Example 33

Polyvinyl butyral was synthesized as described for Comparative Example 24, except that the starting PVA was changed to Comparative PVA-17. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Comparative Example 34

Polyvinyl butyral was synthesized as described for Example 23, except that the starting PVA was changed to Comparative PVA-17. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

### Comparative Example 35

Polyvinyl butyral was synthesized as described for Example 25, except that the starting PVA was changed to Comparative PVA-17. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 9.

TABLE 9

| | | | | | | | | | Evaluation | | | |
|---|---|---|---|---|---|---|---|---|---|---|---|---|
| | | | Degree | Vinyl | Vinyl | | | | Storage | Amount of | Storage | Amount of |
| | | Degree | of | acetate | alcohol | | | | stability | carbon | stability | carbon |
| | | of | acetali- | monomer | monomer | | | | of | residue | of | residue in |
| | Starting | polymeri- | zation | unit | unit | (A − | Absorbance | Mw/ | ceramic | in green | conductive | conductive |
| Examples | PVA | zation | (mol %) | (mol %) | (mol %) | B)/A | (280 nm) | Mn | slurry | sheet | paste | paste |
| Example 16 | PVA-13 | 1700 | 74.1 | 8.1 | 17.8 | 0.21 | 4.62 × 10⁻³ | 5.5 | A | A | A | A |
| Example 17 | PVA-14 | 1700 | 74.3 | 8.0 | 17.7 | 0.48 | 2.76 × 10⁻³ | 5.1 | B | A | B | A |
| Example 18 | PVA-15 | 1700 | 74.2 | 7.9 | 17.9 | 0.15 | 8.76 × 10⁻³ | 5.6 | A | B | A | B |
| Example 19 | PVA-16 | 1700 | 74.4 | 8.2 | 17.4 | 0.48 | 6.12 × 10⁻³ | 11.8 | B | B | B | B |
| Example 20 | PVA-17 | 1700 | 74.3 | 8.3 | 17.4 | 0.45 | 4.08 × 10⁻³ | 9.3 | B | B | B | B |
| Example 21 | PVA-18 | 1700 | 74.3 | 8.1 | 17.6 | 0.52 | 6.92 × 10⁻³ | 13.3 | B | B | B | B |
| Example 22 | PVA-19 | 1700 | 74.2 | 8.0 | 17.8 | 0.09 | 1.76 × 10⁻³ | 4.5 | B | A | B | A |
| Example 23 | PVA-13 | 1700 | 55.3 | 8.8 | 35.9 | 0.19 | 4.73 × 10⁻³ | 5.3 | B | A | B | A |
| Example 24 | PVA-13 | 1700 | 63.2 | 8.5 | 28.3 | 0.20 | 4.68 × 10⁻³ | 5.4 | B | A | B | A |
| Example 25 | PVA-13 | 1700 | 78.5 | 7.5 | 14.0 | 0.49 | 4.59 × 10⁻³ | 5.6 | A | B | A | B |
| Comparative | PVA-13 | 1700 | 46.3 | 9.1 | 44.6 | 0.18 | 4.79 × 10⁻³ | 5.2 | C | B | C | B |
| Example 24 | | | | | | | | | | | | |
| Comparative | PVA-13 | 1700 | 86.1 | 5.8 | 8.1 | 0.50 | 4.52 × 10⁻³ | 5.7 | B | C | B | C |
| Example 25 | | | | | | | | | | | | |
| Comparative | Comparative | 1700 | 74.1 | 8.2 | 17.7 | 0.54 | 0.46 × 10⁻³ | 4.9 | C | A | C | A |
| Example 26 | PVA-16 | | | | | | | | | | | |
| Comparative | Comparative | 1700 | 74.3 | 8.0 | 17.7 | 0.07 | 16.48 × 10⁻³ | 6.2 | A | C | A | C |
| Example 27 | PVA-17 | | | | | | | | | | | |
| Comparative | Comparative | 1700 | 74.4 | 8.1 | 17.5 | 0.58 | 0.42 × 10⁻³ | 11.1 | C | A | C | A |
| Example 28 | PVA-18 | | | | | | | | | | | |
| Comparative | Comparative | 1700 | 74.3 | 8.0 | 17.7 | 0.15 | 15.28 × 10⁻³ | 12.2 | B | C | B | C |
| Example 29 | PVA-19 | | | | | | | | | | | |
| Comparative | Comparative | 1700 | 46.2 | 9.2 | 44.6 | 0.52 | 0.45 × 10⁻³ | 4.6 | C | A | C | A |
| Example 30 | PVA-16 | | | | | | | | | | | |
| Comparative | Comparative | 1700 | 55.5 | 8.9 | 35.6 | 0.58 | 0.48 × 10⁻³ | 4.7 | C | A | C | A |
| Example 31 | PVA-16 | | | | | | | | | | | |
| Comparative | Comparative | 1700 | 78.6 | 7.4 | 14.0 | 0.61 | 0.45 × 10⁻³ | 5.0 | C | A | C | A |
| Example 32 | PVA-16 | | | | | | | | | | | |
| Comparative | Comparative | 1700 | 46.3 | 9.1 | 44.6 | 0.05 | 16.64 × 10⁻³ | 5.9 | B | C | B | C |
| Example 33 | PVA-17 | | | | | | | | | | | |
| Comparative | Comparative | 1700 | 55.2 | 9.0 | 35.8 | 0.06 | 16.59 × 10⁻³ | 6.0 | B | C | B | C |
| Example 34 | PVA-17 | | | | | | | | | | | |
| Comparative | Comparative | 1700 | 78.6 | 7.4 | 14.0 | 0.09 | 16.33 × 10⁻³ | 6.3 | B | C | B | C |
| Example 35 | PVA-17 | | | | | | | | | | | |

When the binders for ceramic formation in Examples 16 to 25 were used, the stability of the ceramic slurry was improved. In addition, when the binders for ceramic formation were used, the amount of carbon residue in the ceramic green sheet was less. In contrast, when a binder for ceramic formation not satisfying the conditions defined in the present invention was used (Comparative Examples 24 to 35), any of the performances was reduced.

When a binder for a conductive paste of the present invention was used in a similar manner as a binder for a conductive paste containing polyvinyl acetal having completely saponified PVA with a degree of polymerization of 1700 as a starting material (Examples 16 to 25), the storage stability of the conductive paste was improved. In addition, when a binder for a conductive paste of the present invention was used, the amount of carbon residue was less. In contrast, when a binder for a conductive paste not satisfying the conditions defined in the present invention was used (Comparative Examples 24 to 35), any of the performances was reduced.

### Example 26

In a 10 liter glass vessel equipped with a reflux condenser, a thermometer, and an anchor type impeller were charged 8100 of ion-exchanged water and 660 g of PVA-20 (PVA concentration: 7.5%), and the contents were heated to 95° C. to completely dissolve the PVA. Then, the contents were gradually cooled to 1° C. over about 60 min. with stirring at 120 rpm. Then, to the vessel were added 468 g of n-butyraldehyde and 540 mL of 20% hydrochloric acid, to carry out a butyralation reaction for 90 min. Then, the mixture was heated to 25° C. over 30 min., kept at 25° C. for 180 min., and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral.

The composition of polyvinyl butyral thus obtained was measured as described for Example 1. The degree of butyralation (degree of acetalization) was 73.2 mol %, the content of a vinyl acetate monomer unit was 8.0 mol %, and the content of a vinyl alcohol monomer unit was 18.8 mol %. Then, the evaluation (GPC measurement) of polyvinyl acetal thus obtained and the storage stability and the amount of carbon residue in the conductive paste were evaluated as described for Example 16. The results are shown in Table 10.

### Example 27

In a 10 liter glass vessel equipped with a reflux condenser, a thermometer, and an anchor type impeller were charged 8100 of ion-exchanged water and 660 g of PVA-21 (PVA concentration: 7.5%), and the contents were heated to 95° C. to completely dissolve the PVA. Then, the contents were gradually cooled to 5° C. over about 60 min. with stirring at 120 rpm. Then, to the vessel were added 450 g of n-butyraldehyde and 540 mL of 20% hydrochloric acid, to carry out a butyralation reaction for 90 min. Then, the mixture was heated to 30° C. over 30 min., kept at 30° C. for 180 min., and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral.

The composition of polyvinyl butyral thus obtained was measured as described for Example 1. The degree of butyralation (degree of acetalization) was 74.3 mol %, the content of a vinyl acetate monomer unit was 7.9 mol %, and the content of a vinyl alcohol monomer unit was 17.8 mol %. Then, the evaluation (GPC measurement) of polyvinyl acetal thus obtained and the storage stability and the amount of carbon residue in the conductive paste were evaluated as described for Example 16. The results are shown in Table 10.

### Comparative Examples 36 and 37

Polyvinyl butyral was synthesized as described for Example 26, except that the starting PVA was changed as shown in Table 10. Then, the storage stability and the amount of carbon residue in the conductive paste were evaluated as described for Example 1. The results are shown in Table 10.

### Comparative Example 38

Polyvinyl butyral was synthesized as described for Example 26, except that the starting PVA was changed to Comparative PVA-23. Then, the storage stability and the amount of carbon residue in the conductive paste were evaluated as described for Example 1. The results are shown in Table 10.

### Comparative Examples 39 and 40

Polyvinyl butyral was synthesized as described for Example 27, except that the starting PVA was changed as shown in Table 10. Then, the storage stability and the amount of carbon residue in the conductive paste were evaluated as described for Example 1. The results are shown in Table 10.

TABLE 10

| | | | | Vinyl | Vinyl | | | | | |
|---|---|---|---|---|---|---|---|---|---|---|
| | | | Degree of | acetate | alcohol | | | | Evaluation | |
| | | Degree of | acetaliza- | monomer | monomer | | | | Storage | Amount of carbon |
| | Starting | polymeri- | tion | unit | unit | (A − | Absorbance | | stability of | residue in |
| Examples | PVA | zation | (mol %) | (mol %) | (mol %) | B)/A | (280 nm) | Mw/Mn | conductive paste | conductive paste |
| Example 26 | PVA-20 | 300 | 73.2 | 8.0 | 18.8 | 0.08 | 7.44 × 10⁻³ | 6.2 | B | B |
| Example 27 | PVA-21 | 500 | 74.3 | 7.9 | 17.8 | 0.16 | 4.851 × 10⁻³ | 5.7 | A | A |
| Comparative | Comparative | 300 | 73.2 | 8.0 | 18.8 | 0.47 | 0.46 × 10⁻³ | 5.6 | C | A |
| Example 36 | PVA-20 | | | | | | | | | |
| Comparative | Comparative | 300 | 73.9 | 8.1 | 18.0 | 0.07 | 19.40 × 10⁻³ | 6.2 | B | C |
| Example 37 | PVA-21 | | | | | | | | | |
| Comparative | Comparative | 300 | 54.3 | 33.3 | 12.4 | 0.06 | 12.42 × 10⁻³ | 7.0 | C | C |
| Example 38 | PVA-23 | | | | | | | | | |
| Comparative | Comparative | 500 | 74.2 | 8.2 | 17.6 | 0.56 | 0.48 × 10⁻³ | 5.4 | C | A |
| Example 39 | PVA-24 | | | | | | | | | |
| Comparative | Comparative | 500 | 74.3 | 8.1 | 17.6 | 0.06 | 18.64 × 10⁻³ | 6.4 | A | C |
| Example 40 | PVA-25 | | | | | | | | | |

When a binder for a conductive paste of the present invention was used (Examples 26 and 27), the storage stability of the conductive paste was improved. In addition, when a binder for a conductive paste of the present invention was used, the amount of carbon residue was less. In contrast, when a binder for a conductive paste not satisfying the conditions defined in the present invention was used (Comparative Examples 36 to 40), any of the performances was reduced.

### Example 28

In a 10 liter glass vessel equipped with a reflux condenser, a thermometer, and an anchor type impeller were charged 8234 of ion-exchanged water and 526 g of PVA-22 (PVA concentration: 6.0%), and the contents were heated to 95° C. to completely dissolve the PVA. Then, the contents were gradually cooled to 15° C. over about 60 min. with stirring at 120 rpm. Then, to the vessel were added 344 g of n-butyraldehyde and 540 mL of 20% hydrochloric acid, to carry out a butyralation reaction for 90 min. Then, the mixture was heated to 45° C. over 30 min., kept at 45° C. for 180 min., and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral.

The composition of polyvinyl butyral thus obtained was measured as described for Example 1. The degree of butyralation (degree of acetalization) was 74.6 mol %, the content of a vinyl acetate monomer unit was 8.3 mol %, and the content of a vinyl alcohol monomer unit was 17.1 mol %. Then, the evaluation (GPC measurement) of polyvinyl acetal thus obtained, the storage stability of the ceramic slurry, the amount of carbon residue in the ceramic green sheet, the storage stability of the conductive paste, and the amount of carbon residue in the conductive paste were evaluated as described for Example 1. The results are shown in Table 11.

### Example 29

In a 10 liter glass vessel equipped with a reflux condenser, a thermometer, and an anchor type impeller were charged 8234 of ion-exchanged water and 438 g of PVA-23 (PVA concentration: 5.0%), and the contents were heated to 95° C. to completely dissolve the PVA. Then, the contents were gradually cooled to 15° C. over about 60 min. with stirring at 120 rpm. Then, to the vessel were added 265 g of n-butyraldehyde and 540 mL of 20% hydrochloric acid, to carry out a butyralation reaction for 90 min. Then, the mixture was heated to 45° C. over 30 min., kept at 45° C. for 180 min., and then cooled to room temperature. The precipitated resin was washed with ion-exchanged water, followed by adding an excessive aqueous solution of sodium hydroxide for neutralization. Subsequently, the resin was again washed with ion-exchanged water and then dried to provide polyvinyl butyral.

The composition of polyvinyl butyral thus obtained was measured as described for Example 1. The degree of butyralation (degree of acetalization) was 73.2 mol %, the content of a vinyl acetate monomer unit was 8.1 mol %, and the content of a vinyl alcohol monomer unit was 181 mol %. Then, the evaluation (GPC measurement) of polyvinyl acetal thus obtained, the storage stability of the ceramic slurry, the amount of carbon residue in the ceramic green sheet, the storage stability of the conductive paste, and the amount of carbon residue in the conductive paste were evaluated as described for Example 1. The results are shown in Table 11.

### Comparative Examples 41 and 42

Polyvinyl butyral was synthesized as described for Example 28, except that the starting PVA was changed as shown in Table 11. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 11.

### Comparative Examples 43 and 44

Polyvinyl butyral was synthesized as described for Example 29, except that the starting PVA was changed as shown in Table 11. Then, the storage stability of the ceramic slurry, the amount of carbon residue in the ceramic green sheet, the storage stability of the conductive paste, and the amount of carbon residue in the conductive paste were evaluated as described for Example 1. The results are shown in Table 11.

TABLE 11

| | | | | | | | | | Evaluation | | | |
|---|---|---|---|---|---|---|---|---|---|---|---|---|
| | | | Degree | Vinyl | Vinyl | | | | Storage | Amount of | Storage | Amount of |
| | | Degree | of | acetate | alcohol | | | | stability | carbon | stability | carbon |
| | | of | acetali- | monomer | monomer | | | | of | residue | of | residue in |
| | Starting | polymeri- | zation | unit | unit | (A − | Absorbance | Mw/ | ceramic | in green | conductive | conductive |
| Examples | PVA | zation | (mol %) | (mol %) | (mol %) | B)/A | (280 nm) | Mn | slurry | sheet | paste | paste |
| Example 28 | PVA-22 | 2400 | 74.6 | 8.3 | 17.1 | 0.48 | 5.84 × 10⁻³ | 6.3 | A | A | A | A |
| Example 29 | PVA-23 | 3600 | 73.2 | 8.1 | 18.7 | 0.54 | 3.84 × 10⁻³ | 5.4 | B | B | B | B |
| Comparative | Comparative | 2400 | 74.6 | 8.2 | 17.2 | 0.63 | 0.42 × 10⁻³ | 5.1 | C | A | C | A |
| Example 41 | PVA-26 | | | | | | | | | | | |
| Comparative | Comparative | 2400 | 74.5 | 8.1 | 17.4 | 0.10 | 13.12 × 10⁻³ | 6.4 | A | C | A | C |
| Example 42 | PVA-27 | | | | | | | | | | | |
| Comparative | Comparative | 3600 | 73.8 | 7.9 | 18.3 | 0.64 | 0.38 × 10⁻³ | 5.1 | C | A | C | A |
| Example 43 | PVA-28 | | | | | | | | | | | |
| Comparative | Comparative | 3600 | 73.6 | 8.2 | 18.2 | 0.21 | 13.52 × 10⁻³ | 6.4 | B | C | B | C |
| Example 44 | PVA-29 | | | | | | | | | | | |

When the binders for ceramic formation of Examples 28 and 29 were used, the stability of the ceramic slurry was improved. In addition, when the binders for ceramic formation were used, the amount of carbon residue in the ceramic green sheet was less. In contrast, when a binder for ceramic formation not satisfying the conditions defined in the present invention was used (Comparative Examples 41 to 44), any of the performances was reduced.

When a binder for a conductive paste of the present invention was used (Examples 28 and 29), the storage stability of the conductive paste was improved. In addition, when a binder for a conductive paste of the present invention was used, the amount of carbon residue was less. In contrast, when a binder for a conductive paste not satisfying the conditions defined in the present invention was used (Comparative Examples 41 to 44), any of the performances was reduced.

### Example 30

Polyvinyl butyral was synthesized as described for Example 1, except that the starting PVA was changed as shown in Table 12. Then, the storage stability of the ceramic slurry and the amount of carbon residue in the ceramic green sheet were evaluated as described for Example 1. In addition, the glossiness of the ceramic green sheet and the adhesiveness of the ceramic green sheet were evaluated in the following method. The results are shown in Table 12.

### [Evaluation of Ceramic Green Sheet]

### (Glossiness)

The glossiness of the ceramic green sheet obtained was measured. The glossiness was measured for the surface glossiness of the ceramic green sheet in accordance with JIS Z-8741 (1983) Method 3 using VGS-1D manufactured by Nippon Denshoku Industries Co., Ltd. Greater % in glossiness means more excellent surface smoothness. The results are shown in Table 12.

A: 80% or more

B: not less than 60% and less than 80%

C: less than 60%

If the sheet glossiness is less than 60%, the sheet has low surface properties and it may cause, when formed into a chip, short circuit failure and reduction in adhesiveness.

### (Plasma Radiation Conditions)

The ceramic green sheet thus obtained was cut into the size of 10 cm×10 cm. Then, using an atmospheric pressure plasma device, a surface of the ceramic green sheet was subjected to atmospheric pressure plasma treatment in conditions of a voltage at 11 kV, an interelectrode distance of 2 mm, and a sample moving rate of 10 mm/sec. using mixed gas of nitrogen gas at a flow rate of 150 L/min. and pure dry air at a flow rate of 0.5 L/min. to modify the surface.

### (Preparation of Adhesiveness Test Sample)

A ceramic green sheet subjected to atmospheric pressure plasma treatment and a ceramic green sheet not subjected to atmospheric pressure plasma treatment were laminated and a thermocompression bonding test was conducted in the following conditions using a hot press. Here, lamination was performed so as to contact the surface subjected to atmospheric pressure plasma treatment with a surface of another ceramic green sheet.

### Pressing Temperature: 45° C.

### Pressure: 11 Mpa

Time: 5 seconds

The adhered surfaces in the obtained lamination were visually observed to evaluate the adhesiveness of the ceramic green sheet in the following three grades. The results are shown in Table 12.

A: no delamination was found at all and the adhesion was strong.
B: delamination was found partially
C: delamination was found frequently

### Example 31

Polyvinyl butyral was synthesized as described for Example 16, except that the starting PVA was changed to PVA-A2. Then, the storage stability of the ceramic slurry and the amount of carbon residue in the ceramic green sheet were evaluated as described for Example 1 and the green sheet was evaluated as described for Example 30. The results are shown in Table 12.

### Examples 32 to 35

Polyvinyl butyral was synthesized as described for Example 1, except that the starting PVA was changed as shown in Table 12. Then, the storage stability and the amount of carbon residue in the conductive paste were evaluated as described for Example 1. The glossiness and the adhesiveness were evaluated as described for Example 30. The results are shown in Table 12.

### Example 36

Polyvinyl acetal was synthesized as described for Example 1, except that the starting PVA was changed to 462 g of PVA-A1 and 198 g of PVA-10 according to Table 3 and the temperature after warming was changed to 50° C. Then, the storage stability of the ceramic slurry and the amount of carbon residue in the ceramic green sheet were evaluated as described for Example 1 and the green sheet was evaluated as described for Example 30. The results are shown in Table 12.

### Example 37

Polyvinyl acetal was synthesized as described for Example 14, except that the starting PVA was changed to 368.2 g of PVA-A12 according to Table 3 and 157.8 g of PVA-C according to Table 5 (low degree of polymerization). Then, the storage stability of the ceramic slurry and the amount of carbon residue in the ceramic green sheet were evaluated as described for Example 1 and the green sheet was evaluated as described for Example 30. The results are shown in Table 12.

### Example 38

Using the polyvinyl acetal obtained in Example 1, the glossiness and the adhesiveness were evaluated as described for Example 30. The results are shown in Table 12.

### Example 39

Using the polyvinyl acetal obtained in Example 3, the glossiness and the adhesiveness were evaluated as described for Example 30. The results are shown in Table 12.

### Example 40

Using the polyvinyl acetal obtained in Example 7, the glossiness and the adhesiveness were evaluated as described for Example 30. The results are shown in Table 12.

### Example 41

Using the polyvinyl acetal obtained in Example 10, the glossiness and the adhesiveness were evaluated as described for Example 30. The results are shown in Table 12.

### Example 42

Modified polyvinyl butyral was synthesized as described for Example 1, except that 24.7 g of 4-aminobutyl diethyl acetal (NH-PVB) was used and the amount of n-butyraldehyde was changed to 375 g. Then, the storage stability of the ceramic slurry and the amount of carbon residue in the ceramic green sheet were evaluated as described for Example 1 and the green sheet was evaluated as described for Example 30. The results are shown in Table 12.

### Comparative Example 45

Using the polyvinyl acetal obtained in Comparative Example 3, the glossiness and the adhesiveness were evaluated as described for Example 30. The results are shown in Table 12.

### Comparative Example 46

Using the polyvinyl acetal obtained in Comparative Example 4, the glossiness and the adhesiveness were evaluated as described for Example 30. The results are shown in Table 12.

### Comparative Example 47

Polyvinyl acetal was synthesized as described for Example 1, except that the starting PVA was changed to Comparative PVA-H1. Then, the storage stability of the ceramic slurry and the amount of carbon residue in the ceramic green sheet were evaluated as described for Example 1 and the green sheet was evaluated as described for Example 30. The results are shown in Table 12.

### Comparative Example 48

Polyvinyl acetal was synthesized as described for Example 16, except that the starting PVA was changed to Comparative PVA-H2. Then, the storage stability of the ceramic slurry and the amount of carbon residue in the ceramic green sheet were evaluated as described for Example 1 and the green sheet was evaluated as described for Example 30. The results are shown in Table 12.

TABLE 12

| | | | | Vinyl | Vinyl | | | |
|---|---|---|---|---|---|---|---|---|
| | | | | acetate | alcohol | | | |
| | | | Degree of | monomer | monomer | | Amount of | |
| | Starting | Degree of | acetalization | unit | unit | Modification | modification | (A − |
| Examples | PVA²⁾ | polymerization | (mol %) | (mol %) | (mol %) | type | [mol %] | B)/A |
| Example 30 | PVA-A1 | 1700 | 68.5 | 1.6 | 28.9 | NVA | 1 | 0.19 |
| Example 31 | PVA-A2 | 1700 | 74.2 | 8.3 | 16.5 | NVA | 1 | 0.17 |
| Example 32 | PVA-B | 1700 | 68.9 | 1.3 | 29.3 | NVA | 0.5 | 0.20 |
| Example 33 | PVA-D | 1700 | 68.4 | 1.7 | 28.9 | NVC | 1 | 0.20 |
| Example 34 | PVA-E | 1700 | 68.5 | 1.4 | 29.6 | NVC | 0.5 | 0.21 |
| Example 35 | PVA-G | 1700 | 68.5 | 1.6 | 28.9 | NMMM | 1 | 0.13 |
| Example 36 | PVA-A1(70) | 1300 | 68.4 | 1.6 | 29.3 | NVA | 0.7 | 0.20 |
| | PVA-10(30) | | | | | | | |
| Example 37 | PVA-12(70) | 2400 | 68.4 | 1.4 | 29.9 | NVA | 0.3 | 0.48 |
| | PVA-C(30) | | | | | | | |
| Example 38 | PVA-1 | 1700 | 68.2 | 0.9 | 30.9 | — | — | 0.23 |
| Example 39 | PVA-3 | 1700 | 68.4 | 0.9 | 30.7 | — | — | 0.14 |
| Example 40 | PVA-7 | 1700 | 68.6 | 0.9 | 30.5 | — | — | 0.11 |
| Example 41 | PVA-1 | 1700 | 64.3 | 0.9 | 34.8 | — | — | 0.21 |
| Example 42 | PVA-1 | 1700 | 66.2 | 0.9 | 30.9 | NH-PVB¹⁾ | 2 | 0.23 |
| Comparative | Comparative | 1700 | 68.2 | 0.8 | 31.0 | — | — | 0.57 |
| Example 45 | PVA-1 | | | | | | | |
| Comparative | Comparative | 1700 | 68.4 | 0.9 | 30.7 | — | — | 0.09 |
| Example 46 | PVA-2 | | | | | | | |
| Comparative | Comparative | 1700 | 68.4 | 1.5 | 29.1 | NVA | 1 | 0.61 |
| Example 47 | PVA-H1 | | | | | | | |
| Comparative | Comparative | 1700 | 74.1 | 8.2 | 16.7 | NVA | 1 | 0.53 |
| Example 48 | PVA-H2 | | | | | | | |

| | | | Evaluation | | | | |
|---|---|---|---|---|---|---|---|
| | | | | Amount of | Glossiness | | Application |
| | Absorbance | | Storage | carbon | of green | Sheet | of plasma |
| Examples | (280 nm) | Mw/Mn | stability | residue | sheet | adhesiveness | treatment |
| Example 30 | 3.12 × 10⁻³ | 3.3 | A | A | A | A | Applied |
| Example 31 | 4.87 × 10⁻³ | 5.4 | A | B | A | A | Applied |
| Example 32 | 2.67 × 10⁻³ | 3.4 | B | A | B | A | Applied |
| Example 33 | 2.94 × 10⁻³ | 3.6 | A | A | A | A | Applied |
| Example 34 | 2.58 × 10⁻³ | 3.3 | B | A | B | A | Applied |
| Example 35 | 3.57 × 10⁻³ | 3.4 | B | A | B | A | Applied |
| Example 36 | 2.96 × 10⁻³ | 4.7 | A | A | A | A | Applied |
| Example 37 | 2.30 × 10⁻³ | 6.8 | B | A | B | A | Applied |
| Example 38 | 2.21 × 10⁻³ | 3.4 | A | A | A | B | Applied |
| Example 39 | 4.70 × 10⁻³ | 3.3 | A | B | A | B | Applied |
| Example 40 | 0.67 × 10⁻³ | 2.7 | B | A | B | B | Applied |
| Example 41 | 2.27 × 10⁻³ | 3.3 | B | A | B | B | Applied |
| Example 42 | 2.21 × 10⁻³ | 3.4 | A | A | A | A | Applied |
| Comparative | 0.36 × 10⁻³ | 2.9 | C | A | C | C | Applied |
| Example 45 | | | | | | | |
| Comparative | 10.88 × 10⁻³ | 3.7 | A | C | A | C | Applied |
| Example 46 | | | | | | | |
| Comparative | 0.44 × 10⁻³ | 3.3 | C | A | C | C | Applied |
| Example 47 | | | | | | | |
| Comparative | 0.46 × 10⁻³ | 5.5 | C | A | C | C | Applied |
| Example 48 | | | | | | | |

¹⁾Modification by functional group of aldehyde used for acetalization.
²⁾A value in parentheses is a mixing mass ratio of PVAc.

When the binders for ceramic formation in Examples 30 to 42 were used, the storage stability of the ceramic slurry was improved. In addition, when the binders for ceramic formation were used, the amount of carbon residue in the ceramic green sheet was less. Further, the green sheets obtained had high surface glossiness. By applying atmospheric pressure plasma radiation, the green sheets of Examples 30 to 37 and 42 exhibited very good adhesiveness and those of Examples 38 to 41 also exhibited good adhesiveness. In contrast, when a binder for ceramic formation not satisfying the conditions defined in the present invention was used (Comparative Examples 45 to 48), any of the performances was reduced.

As shown from the above results, when a binder for ceramic formation of the present invention was used, the storage stability of the ceramic slurry was excellent. In addition, the amount of carbon residue produced during heating and sintering of the ceramic green sheet was less, and the adhesiveness between the green sheets was improved. In contrast, when a binder for ceramic formation not satisfying the conditions defined in the present invention was used, any of the performances was clearly reduced.

### Example 43

Polyvinyl butyral was synthesized as described for Example 1, except that the starting PVA was changed as shown in Table 13. Then, the storage stability and the amount of carbon residue in the conductive paste were evaluated as described for Example 1. In addition, the glossiness of the coated sheet and the adhesiveness of the coated sheet were evaluated in the following method. The results are shown in Table 13.

### (Production of Ceramic Slurry)

To a mixed solvent of 30 parts by mass of toluene and 30 parts by mass of ethanol, 15 parts by mass of polyvinyl butyral (PVB-1) was added and then stirred to dissolve polyvinyl butyral. To the solution, 3 parts by mass of dioctyl phthalate was added as a plasticizer and then stirred to dissolve the plasticizer. To the resin solution thus obtained, 100 parts by mass of barium titanate (“BT-02” manufactured by Sakai Chemical Industry Co., Ltd., average particle size of 0.2 μm) was added as ceramic powder and mixed in a ball mill for 24 hours to provide a ceramic slurry.

### (Production of Ceramic Green Sheet)

The ceramic slurry thus obtained was coated on a polyester film subjected to release treatment in such an amount that a thickness after drying was to be approximately 10 μm and air dried at ordinary temperature for 1 hour, and then dried at a temperature of 80° C. for 3 hours and subsequently at a temperature of 120° C. for 2 hours using a hot air dryer to provide a ceramic green sheet.

### (Production of Conductive Paste)

The conductive paste thus obtained was coated on the ceramic green sheet by screen printing to prepare a conductive paste coated sheet (hereinafter, may be abbreviated as “a coated sheet”).

### (Glossiness)

The glossiness of the coated sheet obtained was measured. The glossiness was measured for the surface coated with the conductive paste in accordance with JIS Z-8741 (1997) Method 3 using VGS-1D manufactured by Nippon Denshoku Industries Co., Ltd. Greater % in glossiness means more excellent surface smoothness. The results are shown in Table 13.

A: 80% or more

B: not less than 60% and less than 80%

C: less than 60%

If the sheet glossiness is less than 60%, the sheet has low surface properties and it may cause reduction in adhesiveness during thermocompression bonding and short circuit failure when formed into a chip.

### (Plasma Radiation Conditions)

The coated sheet thus obtained was cut into the size of 10 cm×10 cm. Then, using an atmospheric pressure plasma device, a surface coated with a conductive paste was subjected to atmospheric pressure plasma treatment in conditions of a voltage at 11 kV, an interelectrode distance of 2 mm, and a sample moving rate of 10 mm/sec. using mixed gas of nitrogen gas at a flow rate of 150 L/min. and pure dry air at a flow rate of 0.5 L/min. to modify the surface.

### (Preparation of Adhesiveness Test Sample)

A ceramic green sheet produced in the above method was prepared. This ceramic green sheet and a coated sheet subjected to atmospheric pressure plasma treatment were laminated and a thermocompression bonding test was conducted in the following conditions using a hot press. Here, lamination was performed so as to contact the surface subjected to atmospheric pressure plasma treatment with a surface of another ceramic green sheet.

### Pressing Temperature: 45° C.

### Pressure: 1 Mpa

Time: 5 seconds

The interlayer adhesiveness between the green sheet and the coated sheet in the obtained lamination were visually observed to evaluate the adhesiveness between the green sheet and the coated sheet in the following three grades. The results are shown in Table 13.

A: no delamination was found at all and the adhesion was strong.
B: delamination was found partially
C: delamination was found frequently

### Example 44

Polyvinyl butyral was synthesized as described for Example 16, except that the starting PVA was changed to PVA-A2. Then, the storage stability and the amount of carbon residue in the conductive paste were evaluated as described for Example 1. The glossiness and the adhesiveness were evaluated as described for Example 43. The results are shown in Table 13.

### Examples 45 to 48

Polyvinyl butyral was synthesized as described for Example 1, except that the starting PVA was changed as shown in Table 13. Then, the storage stability and the amount of carbon residue in the conductive paste were evaluated as described for Example 1. The glossiness and the adhesiveness were evaluated as described for Example 43. The results are shown in Table 13.

### Example 49

Polyvinyl acetal was synthesized as described for Example 1, except that the starting PVA was changed to 462 g of PVA-A1 and 198 g of PVA-10 according to Table 5 and the temperature after warming was changed to 50° C. Then, the storage stability and the amount of carbon residue in the conductive paste were evaluated as described for Example 1. The glossiness and the adhesiveness were evaluated as described for Example 43. The results are shown in Table 13.

### Example 50

Polyvinyl acetal was synthesized as described for Example 14, except that the starting PVA was changed to 368.2 g of PVA-12 according to Table 3 and 157.8 g of PVA-C. Then, the storage stability and the amount of carbon residue in the conductive paste were evaluated as described for Example 1. The glossiness and the adhesiveness were evaluated as described for Example 43. The results are shown in Table 13.

### Example 51

Using the polyvinyl acetal obtained in Example 1, the glossiness and the adhesiveness were evaluated as described for Example 43. The results are shown in Table 13.

### Example 52

Using the polyvinyl acetal obtained in Example 3, the glossiness and the adhesiveness were evaluated as described for Example 43. The results are shown in Table 13.

### Example 53

Using the polyvinyl acetal obtained in Example 7, the glossiness and the adhesiveness were evaluated as described for Example 43. The results are shown in Table 13.

### Example 54

Using the polyvinyl acetal obtained in Example 10, the glossiness and the adhesiveness were evaluated as described for Example 43. The results are shown in Table 13.

### Example 55

Modified polyvinyl butyral was synthesized as described for Example 1, except that 21.5 g of 4-aminobutyl diethyl acetal (NH-PVB) was used and the amount of n-butyraldehyde was changed to 375 g. Then, the storage stability and the amount of carbon residue in the conductive paste were evaluated as described for Example 1. The glossiness and the adhesiveness were evaluated as described for Example 43. The results are shown in Table 13.

### Example 56

Polyvinyl acetal was synthesized as described for Example 1, except that the starting PVA was changed to PVA-C. Then, the storage stability and the amount of carbon residue in the conductive paste were evaluated as described for Example 1. The glossiness and the adhesiveness were evaluated as described for Example 43. The results are shown in Table 13.

### Example 57

Polyvinyl acetal was synthesized as described for Example 1, except that the starting PVA was changed to PVA-F. Then, the storage stability and the amount of carbon residue in the conductive paste were evaluated as described for Example 1. The glossiness and the adhesiveness were evaluated as described for Example 43. The results are shown in Table 13.

### Comparative Example 49

Using the polyvinyl acetal obtained in Comparative Example 3, the glossiness and the adhesiveness were evaluated as described for Example 43. The results are shown in Table 13.

### Comparative Example 50

Using the polyvinyl acetal obtained in Comparative Example 4, the glossiness and the adhesiveness were evaluated as described for Example 43. The results are shown in Table 13.

### Comparative Example 51

Polyvinyl acetal was synthesized as described for Example 1, except that the starting PVA was changed to Comparative PVA-H1. Then, the storage stability and the amount of carbon residue in the conductive paste were evaluated as described for Example 1. The glossiness and the adhesiveness were evaluated as described for Example 43. The results are shown in Table 13.

### Comparative Example 52

Polyvinyl acetal was synthesized as described for Example 16, except that the starting PVA was changed to Comparative PVA-H2. Then, the storage stability and the amount of carbon residue in the conductive paste were evaluated as described for Example 1. The glossiness and the adhesiveness were evaluated as described for Example 43. The results are shown in Table 13.

TABLE 13

| | | | | Vinyl | Vinyl | | | |
|---|---|---|---|---|---|---|---|---|
| | | | | acetate | alcohol | | | |
| | | | Degree of | monomer | monomer | | Amount of | |
| | Starting | Degree of | acetalization | unit | unit | Modification | modification | (A − |
| Examples | PVA²⁾ | polymerization | (mol %) | (mol %) | (mol %) | type | [mol %] | B)/A |
| Example 43 | PVA-A1 | 1700 | 68.5 | 1.6 | 28.9 | NVA | 1 | 0.19 |
| Example 44 | PVA-A2 | 1700 | 74.2 | 8.3 | 16.5 | NVA | 1 | 0.17 |
| Example 45 | PVA-B | 1700 | 68.9 | 1.3 | 29.3 | NVA | 0.5 | 0.20 |
| Example 46 | PVA-D | 1700 | 68.4 | 1.7 | 28.9 | NVC | 1 | 0.20 |
| Example 47 | PVA-E | 1700 | 68.5 | 1.4 | 29.6 | NVC | 0.5 | 0.21 |
| Example 48 | PVA-G | 1700 | 68.5 | 1.6 | 28.9 | NMMM | 1 | 0.13 |
| Example 49 | PVA-A1(70) | 1300 | 68.4 | 1.6 | 29.3 | NVA | 0.7 | 0.20 |
| | PVA-10(30) | | | | | | | |
| Example 50 | PVA-12(70) | 2400 | 68.4 | 1.4 | 29.9 | NVA | 0.3 | 0.48 |
| | PVA-C(30) | | | | | | | |
| Example 51 | PVA-1 | 1700 | 68.2 | 0.9 | 30.9 | — | — | 0.23 |
| Example 52 | PVA-3 | 1700 | 68.4 | 0.9 | 30.7 | — | — | 0.14 |
| Example 53 | PVA-7 | 1700 | 68.6 | 0.9 | 30.5 | — | — | 0.11 |
| Example 54 | PVA-1 | 1700 | 64.3 | 0.9 | 34.8 | — | — | 0.21 |
| Example 55 | PVA-1 | 1700 | 66.2 | 0.9 | 30.9 | NH-PVB¹⁾ | 2 | 0.23 |
| Example 56 | PVA-C | 500 | 68.8 | 1.8 | 28.4 | NVA | 1 | 0.15 |
| Example 57 | PVA-F | 500 | 68.1 | 1.9 | 25.0 | NVC | 5 | 0.12 |
| Comparative | Comparative | 1700 | 68.2 | 0.8 | 31.0 | — | — | 0.57 |
| Example 49 | PVA-1 | | | | | | | |
| Comparative | Comparative | 1700 | 68.4 | 0.9 | 30.7 | — | — | 0.09 |
| Example 50 | PVA-2 | | | | | | | |
| Comparative | Comparative | 1700 | 68.4 | 1.5 | 29.1 | NVA | 1 | 0.61 |
| Example 51 | PVA-H1 | | | | | | | |
| Comparative | Comparative | 1700 | 74.1 | 8.2 | 16.7 | NVA | 1 | 0.53 |
| Example 52 | PVA-H2 | | | | | | | |

| | | | Evaluation | | | | |
|---|---|---|---|---|---|---|---|
| | | | | Amount | Glossiness | | Application |
| | Absorbance | | Storage | of carbon | of coated | Sheet | of plasma |
| Examples | (280 nm) | Mw/Mn | stability | residue | sheet | adhesiveness | treatment |
| Example 43 | 3.12 × 10⁻³ | 3.3 | A | A | A | A | Applied |
| Example 44 | 4.87 × 10⁻³ | 5.4 | A | B | A | A | Applied |
| Example 45 | 2.67 × 10⁻³ | 3.4 | B | A | B | A | Applied |
| Example 46 | 2.94 × 10⁻³ | 3.6 | A | A | A | A | Applied |
| Example 47 | 2.58 × 10⁻³ | 3.3 | B | A | B | A | Applied |
| Example 48 | 3.57 × 10⁻³ | 3.4 | B | A | B | A | Applied |
| Example 49 | 2.96 × 10⁻³ | 4.7 | A | A | A | A | Applied |
| Example 50 | 2.30 × 10⁻³ | 6.8 | B | A | B | A | Applied |
| Example 51 | 2.21 × 10⁻³ | 3.4 | A | A | A | B | Applied |
| Example 52 | 4.70 × 10⁻³ | 3.3 | A | B | A | B | Applied |
| Example 53 | 0.67 × 10⁻³ | 2.7 | B | A | B | B | Applied |
| Example 54 | 2.27 × 10⁻³ | 3.3 | B | A | B | B | Applied |
| Example 55 | 2.21 × 10⁻³ | 3.4 | A | A | A | A | Applied |
| Example 56 | 3.64 × 10⁻³ | 3.5 | B | A | A | A | Applied |
| Example 57 | 4.66 × 10⁻³ | 3.8 | B | A | A | A | Applied |
| Comparative | 0.36 × 10⁻³ | 2.9 | C | A | C | C | Applied |
| Example 49 | | | | | | | |
| Comparative | 10.88 × 10⁻³ | 3.7 | A | C | A | C | Applied |
| Example 50 | | | | | | | |
| Comparative | 0.44 × 10⁻³ | 3.3 | C | A | C | C | Applied |
| Example 51 | | | | | | | |
| Comparative | 0.46 × 10⁻³ | 5.5 | C | A | C | C | Applied |
| Example 52 | | | | | | | |

¹⁾Modification by functional group of aldehyde used for acetalization.
²⁾A value in parentheses is a mixing mass ratio of PVAc.

When the binders for a conductive paste of Examples 43 to 57 were used, the storage stability of the conductive paste was improved. In addition, when a binder for a conductive paste of the present invention was used, the amount of carbon residue was less. Further, a lamination obtained therefrom had high surface glossiness. By applying atmospheric pressure plasma radiation, the results of Examples 43 to 50 and 55 to 57 exhibited very good adhesiveness with a green sheet and Examples 51 to 54 also exhibited good adhesiveness. In contrast, when a binder for a conductive paste not satisfying the conditions defined in the present invention was used (Comparative Examples 49 to 52), any of the performances was reduced.

As shown from the above results, when a binder for a conductive paste of the present invention was used, the conductive paste had excellent stability. In addition, the amount of carbon residue produced during heating of the conductive paste was less, and further, the adhesiveness with a green sheet was improved. In contrast, when a binder for a conductive paste not satisfying the conditions defined in the present invention was used, any of the performances was clearly reduced.

1: A binder, comprising
a polyvinyl acetal having a degree of acetalization of from 50 to 85 mol %, a content of vinyl ester monomer unit of from 0.1 to 20 mol %, and having a viscosity-average degree of polymerization of from 200 to 5000, wherein
a peak-top molecular weight (A) as measured by a differential refractive index detector and a peak-top molecular weight (B) as measured by an absorptiometer, at a measurement wavelength of 280 nm, in a gel permeation chromatographic measurement of the polyvinyl acetal heated at 230° C. for 3 hours satisfy a formula (1)
(A−B)/A<0.60 (1)
and the polyvinyl acetal has an absorbance in the peak-top molecular weight (B) of from 0.50×10⁻³ to 1.00×10⁻².

2: The binder of claim 1, wherein the polyvinyl acetal has a ratio Mw/Mn of a weight-average molecular weight Mw to a number-average molecular weight Mn as measured by the differential refractive index detector in the gel permeation chromatographic measurement of from 2.8 to 12.0.

3: The binder of claim 1, wherein the polyvinyl acetal is polyvinyl butyral.

4: The binder of claim 1, wherein the polyvinyl acetal has, in a side chain, at least one functional group selected from the group consisting of an amide group, an amino group, an ester group, a carbonyl group, and a vinyl group.

5: The binder of claim 4, wherein the functional group is an amide group or an amino group.

6: The binder of claim 1, which is a binder suitable for ceramic formation.

7: A ceramic slurry comprising: the binder of claim 6; a ceramic powder; an organic solvent; and a plasticizer.

8: A ceramic green sheet obtained from the ceramic slurry of claim 7.

9: A method of producing a ceramic green sheet, comprising applying an atmospheric pressure plasma treatment on at least one surface of the ceramic green sheet of claim 8.

10: A ceramic green sheet obtained by the method of claim 9.

11: The binder of claim 1, which is a binder suitable for a conductive paste.

12: A conductive paste comprising: the binder of claim 11; a metal powder; and an organic solvent.

13: A coated sheet obtained by coating the conductive paste of claim 12 on a surface of a ceramic green sheet.

14: A method of producing a coated sheet, comprising applying an atmospheric pressure plasma treatment on at least one surface of the coated sheet of claim 13.

15: A coated sheet obtained by the method of claim 14.
